(19) United States
(12) Patent Application Publication
(10) Pub. No.: US 2018/0345709 A1
(43) Pub. Date: Dec. 6, 2018

(54) LASER MARKABLE COMPOSITIONS AND METHODS TO MANUFACTURE A PACKAGING THEREWITH

(71) Applicant: AGFA-GEVAERT, Mortsel (BE)

(72) Inventors: Johan LOCCUFIER, Mortsel (BE); Fabienne GOETHALS, Mortsel (BE); Dirk KOKKELENBERG, Mortsel (BE); Hubertus VAN AERT, Mortsel (BE)

(21) Appl. No.: 15/778,662

(22) PCT Filed: Nov. 29, 2016
(86) PCT No.: PCT/EP2016/079089

§ 371 Date: May 24, 2018

(30) Foreign Application Priority Data
Nov. 30, 2015 (EP) 15196923.5

(51) Int. Cl. B41M 5/323; B41M 5/333; B41M 5/28; B65D 33/00

(52) U.S. Cl. CPC B41M 5/323; B41M 5/3331; B65D 2203/02; B65D 33/004; B41M 2205/38; B41M 5/287

(57) ABSTRACT

A method of manufacturing a packaging, optionally preprinted by flexo or offset, includes the steps of applying one or more laser markable compositions on at least a part of a packaging, and forming a colour image by laser marking the one or more applied laser markable compositions, characterized in that the laser markable compositions include a leucodye, a developing agent or developing agent precursor, and optionally an optothermal converting agent. The method is especially suited for manufacturing a packaging selected from the group consisting of a food packaging, a drink packaging, a cosmetical packaging and a pharmaceutical packaging.

### CROSS REFERENCE TO RELATED APPLICATIONS

This application is a 371 National Stage Application of PCT/EP2016/079089, filed Nov. 29, 2016. This application claims the benefit of European Application No. 15196923.5, filed Nov. 30, 2015, which is incorporated by reference herein in its entirety.

### BACKGROUND OF THE INVENTION

### 1. Field of the Invention

The present invention relates to laser markable compositions and to laser marking methods to prepare a packaging therewith. The laser markable compositions are especially suited for preparing food packaging and pharmaceutical applications.

### 2. Description of the Related Art

Various substrates, for example paper, paperboard or plastics, are very often marked with information such as logos, bar codes, expiry dates or batch numbers.

Traditionally, the marking of these substrates has been achieved by various printing techniques, such as for example inkjet or thermal transfer printing. However, these printing techniques are more and more replaced by laser marking as laser marking is cheaper in terms of overall economics and shows performance benefits such as high speed and contact free marking, marking of substrates with uneven surfaces, creation of marks that are so small that they are invisible or nearly invisible to the human eye, and creation of marks in the substrate rather than on the substrates.

Well known in the field of laser markable security documents is the use of laser markable polymeric supports. Laser marking produces a colour change from white to black in a laser markable support through carbonization of the polymer, usually polycarbonate as disclosed in e.g. EP-A 2181858.

During the past last years, there is an increased interest of using laser markable layers. The advantage of using a laser markable layer applied on a support instead of using a laser markable support, is more variety of supports that may be used, such a glass, metal and polymeric supports with optimized properties, for example in their physical properties or in recycling properties.

There is also an increased interest in using laser marking to produce coloured images, for example in security documents, but also in various other applications. Therefore, laser markable layers are used which are composed of colour forming compounds (also called “leuco dyes”) which can change from essentially colourless or pale-coloured to coloured when exposed to for example heat, such as disclosed in for example EP-A 2648920.

The colour laser markable layers may comprise an infrared absorbing dye (IR dye) or an infrared absorbing pigment (IR pigment), both absorbing the IR radiation and converting it into heat.

An advantage of using IR dyes is that the absorption spectrum of an IR dye tends to be narrower than that of an IR pigment. This allows the production of multicoloured articles and security documents from precursors having a plurality of laser markable layers containing different IR dyes and colour forming compounds. The IR dyes having a different maximum absorption wavelength can then be addressed by IR lasers with corresponding emission wavelengths causing colour formation only in the laser markable layer of the addressed IR dye. Such multicolour articles have been disclosed in for example U.S. Pat. No. 4,720,449, EP-A 2719540 and EP-A 2719541.

Laser marking may also be used to write personalized information onto various articles, such as mobile phones, cars, etc. Here, the major advantage of laser marking compared to for example printing techniques such as inkjet printing, flexographic printing or screen printing is the fact that the information is written “inside” the article instead of “on top” of the article.

Inkjet printing may be used to form coloured images on packaging materials. For example UV curable inks may be used on a variety of substrates.

To provide food packaging with coloured images so called low migration inks have been developed. Ingredients of such low migration inks, for example the photoinitiator, do not migrate through the packaging material into the food. Suitable UV curable inkjet inks for primary food packaging applications, often referred to as Low Migration (LM) inks, are disclosed in for example EP-A 2053101, EP-A 2199273 and EP-A 2161290.

Inkjet printing on a three dimensional packaging material or substrate, for example a bottle or a cup, needs sophisticated printing apparatus, due to the fact that the distance between the packaging material or the substrate and the printhead of the inkjet printer has to be kept as small as possible to ensure good quality printing.

UV curable inkjet inks typically contain acrylic monomers. A disadvantage of using such inks for packaging materials, especially when used in “non-industrial” environments or when used for food packaging, is the typical “acrylic” odour released during printing.

### SUMMARY OF THE INVENTION

Preferred embodiments of the invention provide a method of manufacturing a packaging having a colour image that is suitable for a three dimensional packaging.

Other preferred embodiments of the invention provide a method of manufacturing a food packaging containing a colour image.

Still other preferred embodiments of the present invention provide a laser markable composition especially suited for food packaging and pharmaceutical applications.

A further preferred embodiment of the invention provided a method of manufacturing a packaging having a colour image which is more environmently friendly.

These advantages and benefits have been realized with the method of manufacturing a packaging described below.

Further advantages and embodiments of the present invention will become apparent from the following description.

### DETAILED DESCRIPTION OF THE PREFERRED EMBODIMENTS

### Definitions

The terms polymeric support and foil, as used herein, mean a self-supporting polymer-based sheet, which may be associated with one or more adhesion layers, e.g. subbing layers. Supports and foils are usually manufactured through extrusion.

The term layer as used herein, is considered not to be self-supporting and is manufactured by coating or spraying it on a (polymeric) support or foil. A layer as used herein does not have to cover the complete substrate or support. It may

The term leuco dye as used herein refers to compounds which can change from essentially colourless or pale-coloured to coloured when irradiated with UV light, IR light and/or heated.

PET is an abbreviation for polyethylene terephthalate.

PETG is an abbreviation for polyethylene terephthalate glycol, the glycol indicating glycol modifiers which are incorporated to minimize brittleness and premature aging that occur if unmodified amorphous polyethylene terephthalate (APET) would be used in the production of cards.

PET-C is an abbreviation for crystalline PET, i.e. a biaxially stretched polyethylene terephthalate. Such a polyethylene terephthalate support has excellent properties of dimensional stability.

The definitions of security features correspond with the normal definition as adhered to in the Glossary of Security Documents—Security features and other related technical terms as published by the Consilium of the Council of the European Union on Aug. 25, 2008 (Version: v. 10329.02.b.en) on its website: http://www.consilium.europa.eu/prado/EN/glossaryPopup.html.

The term security document precursor as used herein refers to the fact that one or more security features still have to be applied to the precursor, for example laser marking, in order to obtain the final security document.

The term alkyl means all variants possible for each number of carbon atoms in the alkyl group i.e. methyl, ethyl, for three carbon atoms: n-propyl and isopropyl; for four carbon atoms: n-butyl, isobutyl and tertiary-butyl; for five carbon atoms: n-pentyl, 1,1-dimethyl-propyl, 2,2-dimethylpropyl and 2-methyl-butyl etc.

The term alkoxy means all variants possible for each number of carbon atoms in the alkyl group i.e. methoxy, ethoxy, for three carbon atoms: n-propoxy and isopropoxy; for four carbon atoms: n-butoxy, isobutoxy and tertiary-butoxy etc.

The term aryloxy means Ar—O— wherein Ar is an optionally substituted aryl group.

Unless otherwise specified a substituted or unsubstituted alkyl group is preferably a C₁ to C₆-alkyl group.

Unless otherwise specified a substituted or unsubstituted alkenyl group is preferably a C₂ to C₆-alkenyl group.

Unless otherwise specified a substituted or unsubstituted alkynyl group is preferably a C₂ to C₆-alkynyl group.

Unless otherwise specified a substituted or unsubstituted aralkyl group is preferably a phenyl group or a naphthyl group including one, two, three or more C₁ to C₆-alkyl groups.

Unless otherwise specified a substituted or unsubstituted alkaryl group is preferably a C₁ to C₆-alkyl group including an aryl group, preferably a phenyl group or naphthyl group.

Unless otherwise specified a substituted or unsubstituted aryl group is preferably a substituted or unsubstituted phenyl group or naphthyl group.

A cyclic group includes at least one ring structure and may be a monocyclic- or polycyclic group, meaning one or more rings fused together.

A heterocyclic group is a cyclic group that has atoms of at least two different elements as members of its ring(s).The counterparts of heterocyclic groups are homocyclic groups, the ring structures of which are made of carbon only. Unless otherwise specified a substituted or unsubstituted heterocyclic group is preferably a five- or six-membered ring substituted by one, two, three or four heteroatoms, preferably selected from oxygen atoms, nitrogen atoms, sulfur atoms, selenium atoms or combinations thereof.

An alicyclic group is a non-aromatic homocyclic group wherein the ring atoms consist of carbon atoms.

The term heteroaryl group means a monocyclic- or polycyclic aromatic ring comprising carbon atoms and one or more heteroatoms in the ring structure, preferably, 1 to 4 heteroatoms, independently selected from nitrogen, oxygen, selenium and sulfur. Preferred examples of heteroaryl groups include, but are not limited to, pyridinyl, pyridazinyl, pyrimidyl, pyrazyl, triazinyl, pyrrolyl, pyrazolyl, imidazolyl, (1,2,3,)- and (1,2,4)-triazolyl, pyrazinyl, pyrimidinyl, tetrazolyl, furyl, thienyl, isoxazolyl, thiazolyl, isoxazolyl, and oxazolyl. A heteroaryl group can be unsubstituted or substituted with one, two or more suitable substituents. Preferably, a heteroaryl group is a monocyclic ring, wherein the ring comprises 1 to 5 carbon atoms and 1 to 4 heteroatoms.

The term substituted, in e.g. substituted alkyl group means that the alkyl group may be substituted by other atoms than the atoms normally present in such a group, i.e. carbon and hydrogen. For example, a substituted alkyl group may include a halogen atom or a thiol group. An unsubstituted alkyl group contains only carbon and hydrogen atoms.

Unless otherwise specified a substituted alkyl group, a substituted alkenyl group, a substituted alkynyl group, a substituted aralkyl group, a substituted alkaryl group, a substituted aryl, a substituted heteroaryl and a substituted heterocyclic group are preferably substituted by one or more substituents selected from the group consisting of methyl, ethyl, n-propyl, isopropyl, n-butyl, 1-isobutyl, 2-isobutyl and tertiary-butyl, ester, amide, ether, thioether, ketone, aldehyde, sulfoxide, sulfone, sulfonate ester, sulfonamide, —Cl, —Br, —I, —OH, —SH, —CN and —NO₂.

### Method of Manufacturing a Packaging

The method of preparing a packaging according to the present invention comprises the steps of:
applying one or more laser markable compositions on at least a part of a packaging, and
forming a colour image by laser marking the one or more applied laser markable compositions,
   wherein the laser markable compositions comprise a leucodye, a developing agent or developing agent precursor, and optionally an optothermal converting agent.

Laser marking is preferably carried out using an infrared laser.

The packaging may contain a preprinted image. Such an image is preferably provided on the packaging by flexographic or offset printing.

When the packaging is provided with a preprinted image, it is preferred that variable data are added to the preprinted image by the method according to the present invention.

When a UV curable laser markable composition is used, the applied composition is first exposed to UV radiation, to cure the composition, before laser marking the composition to form the colour image.

The applied laser markable compositions are preferably dried to remove water and organic solvents. Drying is preferably carried out before laser marking.

Suitable drying devices include devices circulating hot air, ovens, and devices using air suction.

A pre-heating device may heat the packaging prior to applying the compositions. The pre-heating device may be an infrared radiation source as described here below, or may be a heat conduction device, such as a hot plate or a heat drum. A preferred heat drum is an induction heat drum.

A heating device uses Carbon Infrared Radiation (CIR) to heat the outside of the substrate quickly. Another preferred drying device is a NIR source emitting near infrared radiation. NIR-radiation energy quickly enters into the depth of the laser markable compositions and removes water and solvents out of the whole layer thickness, while conventional infrared and thermo-air energy predominantly is absorbed at the surface and slowly conducted into the layer, which results usually in a slower removal of water and solvents.

A preferred effective infrared radiation source has an emission maximum between 0.8 and 1.5 μm. Such an infrared radiation source is sometimes called a NIR radiation source or NIR dryer. In a preferred form the NIR radiation source is in the form of NIR LEDs, which can be mounted easily on a shuttling system of a plurality of inkjet print heads in a multi-pass inkjet printing device.

The skilled person knows that he should control the infrared radiation of the drying device in such a manner that the applied laser markable compositions are dried, but no colour formation is started.

A primer layer may be provided between the packaging and the laser markable composition to enhance the adhesion between the composition and the packaging.

When the substrate is transparent, preferably a white primer is provided between the substrate and the laser markable layer, to ensure high intensity colours upon laser marking.

A white primer may also be used on a coloured substrate, to avoid colour contamination of the colours of the image by the colour of the substrate.

The laser markable compositions and the primer may be provided onto the substrate by co-extrusion or any conventional coating technique, such as dip coating, knife coating, extrusion coating, spin coating, spray coating, slide hopper coating and curtain coating.

Alternatively, the laser markable compositions and the primer may be provided onto the substrate by a printing method such as intaglio printing, screen printing, flexographic printing, offset printing, inkjet printing, gravure offset printing, tampon printing, etc.

The laser markable composition may also be applied on a white or preprinted label. Laser marking may be carried out before providing the label on the packaging. However, the label is preferably first provided on the packaging followed by laser marking the label.

When one laser markable composition is used, one colour may be formed. The composition may be optimized, for example by selecting the proper leuco dye, in order to obtain a desired colour.

Multiple colours may be obtained by using two or more laser markable compositions. For example a full colour image may be obtained by using three laser markable compositions forming a cyan or blue, a magenta or red and a yellow colour upon laser marking.

The two or more laser markable compositions preferably comprise an optothermal converting agent making it possible to selectively address the two or more laser markable compositions.

When using two or more laser markable compositions to form a colour image, the compositions preferably comprise an infrared absorbing dye as optothermal converting agent. An advantage of such infrared dyes compared to infrared absorbing pigments is their narrow absorption making a selective addressability of the compositions possible.

When two or more laser markable compositions are used, the absorption maxima of infrared dyes differ by at least 150 nm, more preferably by at least 200 nm, most preferably by at least 250 nm.

According to a preferred embodiment, a first laser markable composition contains a first infrared dye IR-1 having an absorption maximum in the infrared region λₘₐₓ(IR-1), a second laser markable composition contains a second infrared dye IR-2 having an absorption maximum in the infrared region λₘₐₓ(IR-2), and a third laser markable composition contains a third infrared dye IR-3 having an absorption maximum in the infrared region λₘₐₓ(IR-3), wherein the conditions a) and b) are fulfilled:

λₘₐₓ(IR-1)>λₘₐₓ(IR-2)>λₘₐₓ(IR-3); and a)

λₘₐₓ(IR-1)>1100 nm and λₘₐₓ(IR-3)<1000 nm. b)

In a particularly preferred embodiment the condition c) is also fulfilled:

λₘₐₓ(IR-2) differs by at least 60 nm from λₘₐₓ(IR-1) and λₘₐₓ(IR-3). c)

In another preferred embodiment λₘₐₓ(IR-3)≥830 nm and λₘₐₓ(IR-1)≥1125 nm.

According to another embodiment, a single laser markable composition is capable of selectively forming a cyan or blue, a magenta or red and a yellow colour upon exposure with, for example two or more different lasers, each having a different emission wavelength.

### Laser Markable Composition

The laser markable composition comprises a leuco dye and a colour developing agent or colour developing agent precursor. The laser markable composition may further comprise an optothermal converting agent.

The laser markable composition may be water based, solvent based, oil based or UV curable. The laser markable composition is preferably water based or UV curable.

The laser markable composition is most preferably an aqueous composition. An aqueous composition within the meaning of the invention is a composition of which the liquid phase contains preferably at least 50 wt %, more preferably at least 75 wt %, most preferably at least 90 wt % of water.

The laser markable composition according to the present invention may be a laser markable coating or a laser markable ink.

The laser markable ink is preferably selected from the group consisting of an offset ink, a flexo ink, gravure ink and an ink jet ink, a flexo ink and an ink jet ink being particularly preferred.

When the laser markable composition is used for the manufacture of food packaging or pharmaceutical applications, the laser markable composition is preferably a so-called “low migration” laser markable composition.

The term “low migration” packaging is commonly used to designate materials used in the packaging structure whose chemicals will not migrate, or move, from the packaging into the product.

To qualify as low migration packaging, the materials contained in the packaging structure, including printing inks, coatings and adhesives, must not have any migratory chemicals which would affect the appearance, flavour, odour, taste, or the safety of the product contained within the packaging.

The European Printing Ink Association (EuPIA) provides GMP guidelines for food packaging printing inks. In Europe most of the attention today is going to the Swiss legislation (“Ordinance on Materials and Articles in Contact with Food”, SR 817.023.21), promulgating a positive list of compounds. The US Food and Drug Administration (FDA) adheres to the no-migration principle and, therefore, does not impose specific guidelines on inks, except for direct food contact. A key figure in the allowable level of migration and/or set-off for ink compounds is 10 μg/6 dm² (6 dm² is the typical surface area of packaging material for 1 kg of food) per ink compound. This ratio of 10 μg/1 kg of food is also described as 10 ppb and is the rule-of-thumb for the allowable migration limit for an ink compound in the majority of legislations, but this limit can be higher, when substantiated by sufficient toxicological data.

Of course, every packaging structure is different, and every substrate that is printed has different barrier properties. Thus, it is very important to choose the optimal composition for every type of packaging.

A preferred laser markable composition comprises a diffusion hindered leuco dye.

A more preferred laser markable composition comprises a diffusion hindered leuco dye and an diffusion hindered colour developing agent or colour developing agent precursor and optionally an diffusion hindered optothermal converting agent.

A particularly preferred laser markable composition comprises a diffusion hindered leuco dye, a diffusion hindered colour developing agent or colour developing agent precursor and a diffusion hindered infrared dye as optothermal converting agent.

The advantage of a diffusion hindered leuco dye, a diffusion hindered colour developing agent (precursor) and a diffusion hindered optothermal converting agent is the fact that these ingredients do not migrate into the packaging material, possibly causing a health risk when the packaging is a food or pharmaceutical packaging.

A leuco dye, a colour developing agent or colour developing agent precursor and an optothermal converting agent may be rendered “diffusion hindered” by:
including the leuco dye, the colour developing agent or colour developing agent precursor and the optothermal converting agent in the core of a capsule composed of a polymeric shell surrounding a core;
polymerizing or co-polymerizing the leuco dye, the colour developing agent or colour developing agent precursor and the optothermal converting agent to form a polymeric leuco dye, a polymeric colour developing agent or colour developing agent precursor and a polymeric optothermal converting agent; or
linking two or more leuco dyes, colour developing agents or colour developing agent precursors and the optothermal converting agents to each other whereby the total molecular weight of the resulting leuco dye, colour developing agent or colour developing agent precursor and optothermal converting agent becomes at least 500, more preferably at least 750 and most preferably at least 1000; or
linking the leuco dye, the colour developing agent or colour developing agent precursor and the optothermal converting agent into a network upon UV exposure of the laser markable composition.

In the embodiment wherein a UV curable laser markable composition is used, a polymerisable leuco dye, a polymerisable colour developing agent or colour developing agent precursor, or a polymerisable optothermal converting agent is preferably used. Upon UV curing the composition, the polymerisable leuco dye, the polymerisable colour developing agent or colour developing agent precursor, or the polymerisable optothermal converting agent are copolymerized together with the other monomers of the composition. As part of the resulting polymeric network, the leuco dye, the colour developing agent or colour developing agent precursor, or the optothermal converting agent also become diffusion hindered.

In a preferred embodiment, the laser markable composition contains a colour developing agent precursor, so that the colour developing agent is formed from a colour developing agent precursor upon heat treatment. Colour formation now consists of two reaction steps: 1) formation of a colour developing agent followed by 2) reaction with the leuco dye. The advantage of having two reaction steps before colour formation is an enhanced stability, which can be observed by enhanced shelf of the laser markable composition and enhanced light stability of an applied image, especially an invisible image which not yet received any heat treatment.

In a preferred embodiment, a set of two, three or more laser markable compositions are used to form an image on the packaging. The laser markable compositions of the set may contain different leuco dyes or the same leuco dye in different amounts.

In a particularly preferred embodiment, the set of two, three or more laser markable compositions contains at least one laser markable composition containing one or more leuco dyes for forming a cyan or blue colour, at least one laser markable composition containing one or more leuco dyes for forming a magenta or red colour, at least one laser markable composition containing one or more leuco dyes for forming a yellow colour, and optionally at least one laser markable composition containing one or more leuco dyes for forming a black colour. Such a set can be used to form multi colour images.

When using two or more laser markable compositions to form a colour image, the compositions preferably comprise an infrared absorbing dye as optothermal converting agent. An advantage of such infrared dyes compared to infrared absorbing pigments is their narrow absorption making a selective addressability of the compositions possible.

When two or more laser markable compositions are used, the absorption maxima of infrared dyes differ by at least 150 nm, more preferably by at least 200 nm, most preferably by at least 250 nm.

According to a preferred embodiment, a first laser markable composition contains a first infrared dye IR-1 having an absorption maximum in the infrared region λₘₐₓ(IR-1), a second laser markable composition contains a second infrared dye IR-2 having an absorption maximum in the infrared region λₘₐₓ(IR-2), and a third laser markable composition contains a third infrared dye IR-3 having an absorption maximum in the infrared region λₘₐₓ(IR-3), wherein the conditions a) and b) are fulfilled:

λₘₐₓ(IR-1)>λₘₐₓ(IR-2)>λₘₐₓ(IR-3); and a)

λₘₐₓ(IR-1)>1100 nm and λₘₐₓ(IR-3)<1000 nm. b)

In a particularly preferred embodiment the condition c) is also fulfilled:

λₘₐₓ(IR-2) differs by at least 60 nm from λₘₐₓ(IR-1) and λₘₐₓ(IR-3). c)

In another preferred embodiment λₘₐₓ(IR-3)≥830 nm and λₘₐₓ(IR-1)≥1125 nm.

In a more preferred embodiment, the laser markable compositions each contain an opthothermal converting agent having an absorption maximum at a different wavelength, e.g. about 920, 1060 and 1150 nm in the case of three laser markable compositions. Using three lasers each having an emission wavelengths corresponding with the absorption maxima of the optothermal converting agents, the three applied laser markable compositions can be individually addressed.

According to another embodiment, a single laser markable composition is capable of selectively forming a cyan or blue, a magenta or red and a yellow colour upon exposure with, for example two or more different lasers, each having a different emission wavelength. Such a laser markable composition is disclosed in the unpublished PCT/EP2015/061007 (filed 19 May 2015).

A preferred aqueous laser markable composition contains:
two, three or more capsules having a polymeric shell surrounding a core, each capsule containing in its core a leuco dye capable of forming a different colour and an infrared dye having an absorption maximum at different wavelengths,
a colour developing agent or colour developing agent precursor.

Using two, three or more lasers having an emission wavelength corresponding with the absorption maxima of the optothermal converting agents, the different capsules can be selectively addressed, resulting in a multicolour image. A colour image can thus be obtained by using a single laser markable composition instead of using for example three different laser markable compositions as described above.

To maximize the selective addressability of each capsule in the laser markable composition, the absorption maxima of the optothermal converting agents preferably differ by at least 150 nm, more preferably by at least 200 nm, most preferably by at least 250 nm. When three capsules are present, each containing a different optothermal converting agents it is preferred that the absorption maxima of all three optothermal converting agents differ by at least 150 nm.

According to another embodiment, the laser markable composition is a UV curable laser markable ink, preferably a low migration UV curable ink. The radiation curable laser markable ink is preferably selected from a free radical polymerisable ink, a thiol ene based curable ink and a thiol yne based curable ink, a free radical polymerisable ink being particularly preferred.

The UV curable laser markable composition preferably comprises a polymerizable leuco dye and a polymerizable colour developing agent or colour developing agent precursor. Upon exposure to UV radiation, the leuco dye and the colour developing agent (precursor) are copolymerised with the other monomer, thereby forming a polymeric network.

The UV curable laser markable composition preferably comprises diffusion hindered photoinitiatiators and co-initiators, such as disclosed in WO2014/032936 (paragraph [0050] to [0067]), EP-A 205301 (paragraph [0088] to [0097] and US2006014848.

The UV curable laser markable composition preferably comprises at least one vitrification controlling monomer, as disclosed in EP-A 2703457 (paragraph [0053] to [0062]).

The UV curable laser markable composition preferably comprises monomers disclosed in EP-A 2053101 (paragraph [0041] to [0065]).

### Leuco Dye

All publicly-known leuco dyes can be used and are not restricted. They are for example widely used in conventional pressure-sensitive, photosensitive or thermally-sensitive recording materials. For more information about leuco dyes, see for example Chemistry and Applications of Leuco Dyes, Ramaiah Muthyala, Plenum Press, 1997.

A number of classes of leuco dyes may be used as colour forming compounds in the present invention, such as for example: spiropyran leuco dyes such as spirobenzopyrans (e.g. spiroindolinobenzopyrans, spirobenzo-pyranobenzopyrans, 2,2-dialkylchromenes), spironaphtooxazine and spirothiopyran; leuco quinone dyes; azines such as oxazines, diazines, thiazines and phenazine; phthalide- and phthalimidine-type leuco dyes such as triarylmethane phtalides (e.g. crystal violet lactone), diarylmethane phthalides, monoarylmethane phthalides, heterocyclic substituted phthalides, alkenyl substituted phthalides, bridged phthalides (e.g. spirofluorene phthalides and spirobenzanthracene phthalides) and bisphthalides; fluoran leuco dyes such as fluoresceins, rhodamines and rhodols; triarylmethanes such as leuco crystal violet; ketazines; barbituric acid leuco dyes and thiobarbituric acid leuco dyes.

The capsules may comprise more than one leuco dye, typically to obtain a specific desired colour.

The leuco dye is preferably present in the laser markable composition in an amount of 0.05 to 5.00 g/m², more preferably in an amount of 0.10 to 3.00 g/m², most preferably in an amount of 0.20 to 1.00 g/m².

The following reaction mechanisms and leuco dyes are suitable to form a coloured dye.

1. Protonation of a Leuco Dye after Fragmentation of an Acid Generator

The reaction mechanism can be represented by:

Leuco dye+acid generator→Leuco dye+acid→Coloured Dye

Preferred leuco dyes are phthalide- and phthalimidine-type leuco dyes such as triarylmethane phthalides, diarylmethane phthalides, monoarylmethane phthalides, heterocyclic substituted phthalides, alkenyl substituted phthalides, bridged phthalides (e.g. spirofluorene phthalides and spirobenzanthracene phthalides) and bisphthalides; and fluoran leuco dyes such as fluoresceins, rhodamines and rhodols.

In a more preferred embodiment of the present invention, a combination is used of at least one compound selected from the group consisting of CASRN 50292-95-0, CASRN 89331-94-2, CASRN1552-42-7 (crystal violet lactone), CASRN148716-90-9, CASRN 630-88-6, CASRN 36889-76-7 or CASRN 132467-74-4 as the Leuco Dye and at least one compound selected from the group consisting of CASRN 58109-40-3, CASRN 300374-81-6, CASRN 1224635-68-0, CASRN 949-42-8, CASRN 69432-40-2, CASRN 3584-23-4, CASRN 74227-35-3, CASRN 953-91-3 or CASRN6542-67-2 as acid generator.

### 2. Oxidation of a Triarylmethane Leuco Dye

The reaction mechanism can be represented by:

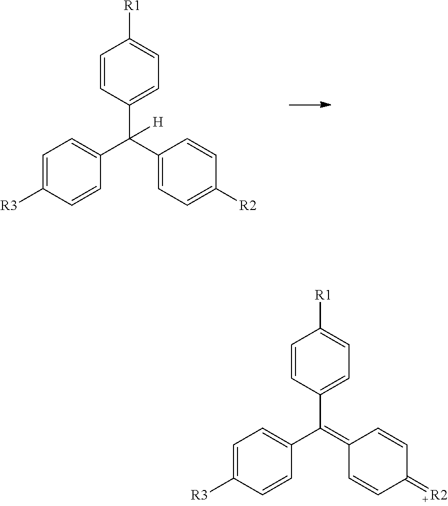

wherein R1, R2 and R3 each independently represent an amino group, an optionally substituted mono- or dialkylamino group, a hydroxyl group or an alkoxy group. R1 and R3 also each independently represent a hydrogen atom or an optionally substituted alkyl, aryl, or heteroaryl group. A preferred leuco dye for the present invention is leuco crystal violet (CASRN 603-48-5).

### 3. Oxidation of a Deuco Quinone Dye

The reaction mechanism can be represented by

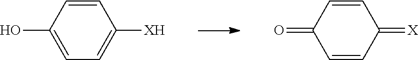

wherein X represents an oxygen atom or an optionally substituted amino or methine group.

### 4. Fragmentation of a Leuco Dye

The reaction mechanism can be represented by:

Leuco Dye-FG→Dye

wherein FG represents a fragmenting group.

Preferred leuco dyes are oxazines, diazines, thiazines and phenazine. A particularly preferred leuco dye (CASRN104434-37-9) is shown in EP 174054 (POLAROID) which discloses a thermal imaging method for forming colour images by the irreversible unimolecular fragmentation of one or more thermally unstable carbamate moieties of an organic compound to give a visually discernible colour shift from colourless to coloured.

The fragmentation of a leuco dye may be catalyzed or amplified by acids, photo acid generators, and thermal acid generators.

### 5. Ring Opening of Spiropyran Leuco Dyes

The reaction mechanism can be represented by:

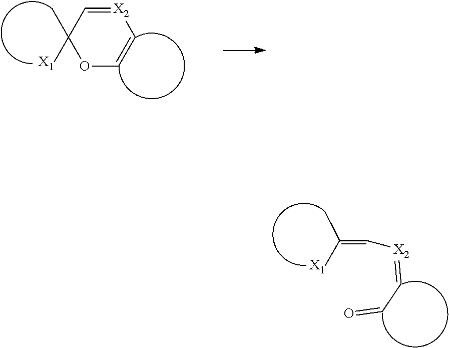

wherein X₁ represents an oxygen atom, an amino group, a sulfur atom or a selenium atom and X₂ represents an optionally substituted methine group or a nitrogen atom.

The preferred spiropyran leuco dyes for the present invention are spiro-benzopyrans such as spiroindolinobenzopyrans, spirobenzopyranobenzopyrans, 2,2-dialkylchromenes; spironaphtooxazines and spirothiopyrans. In a particularly preferred embodiment, the spiropyran leuco dyes are CASRN 160451-52-5 or CASRN 393803-36-6. The ring opening of a spiropyran leuco dye may be catalyzed or amplified by acids, photo acid generators, and thermal acid generators.

In a preferred embodiment of a laser markable layer for producing a cyan colour, the cyan colour forming compound has a structure according to Formulae CCFC1, CCFC2 or CCFC3.

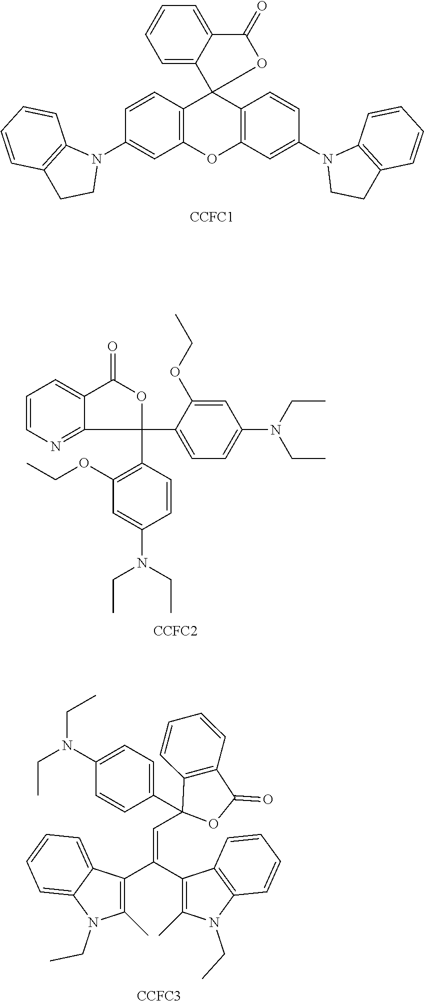

In a preferred embodiment of a laser markable layer for producing a magenta colour, the magenta colour forming compound has a structure according to Formula MCFC2:

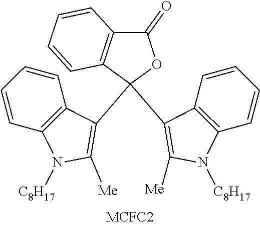

In a preferred embodiment of a laser markable layer for producing a red colour, the red colour forming compound has a structure according to Formula RCFC:

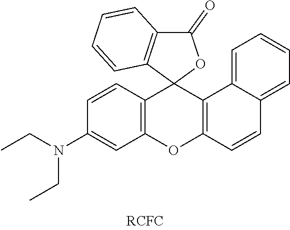 [SMILES: CCN(CC)c1ccc2c(c1)Oc1ccc3ccccc3c1C21OC(=O)c2ccccc21]

In a preferred embodiment of a laser markable layer for producing a yellow colour, the yellow colour forming compound has a structure according to Formula YCFC:

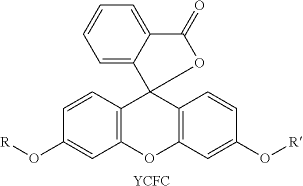

wherein R, R′ are independently selected from a group consisting of a linear alkyl group, a branched alkyl group, an aryl and aralkyl group.

In one embodiment, the yellow colour forming compound has a structure according to Formula YCFC, wherein R and R′ independently represent a linear alkyl group, a branched alkyl group, an aryl or an aralkyl group substituted by at least one functional group containing an oxygen atom, a sulfur atom or a nitrogen atom.

A particularly preferred yellow colour forming compound is the compound according to Formula YCFC wherein both R and R′ are methyl.

In a most preferred embodiment of a laser markable layer for producing a yellow colour, the yellow colour forming compound has a structure according to Formulae YCFC1 or YCFC2.

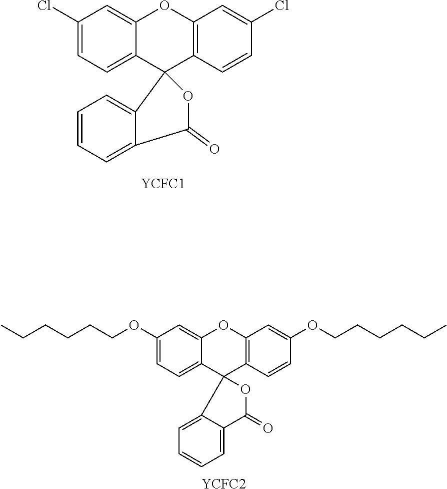

In a preferred embodiment of a laser markable layer for producing a black colour, the black colour forming compound has a structure according to Formula BCFC

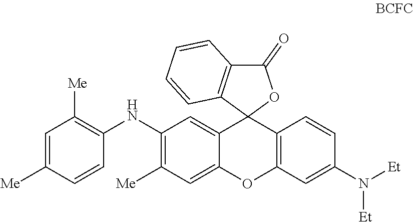

wherein Me=methyl and Et=Ethyl.

Leuco dyes may become “diffusion hindered” by:
including the leuco dye in the core of a capsule composed of a polymeric shell surrounding a core;
polymerizing or co-polymerizing the leuco dye to form a polymeric leuco dye; or
linking two or more basic leuco dyes to each other whereby the total molecular weight of the resulting compound becomes at least twice the molecular weight of the basic ingredient with the proviso that the total molecular weight is at least 500, more preferably at least 750 and most preferably at least 1000.

By using a diffusion hindered leuco dye, the risk of penetrating through a food or pharmaceutical packaging is minimized. Furthermore, the leuco dye cannot be extracted by moisture, e.g. by sweaty hands, before heat treatment or verification of the authenticity of the packaging.

### Capsules

The leuco dye may be become “diffusion hindered” by including the leuco dye in the core of a capsule composed of a polymeric shell surrounding a core.

The capsules have preferably an average particle size of not more than 5 μm, more preferably of not more than 2 μm, most preferably of not more than 1 μm as determined by dynamic laser diffraction. Capsules having an average particle size smaller than 1 μm are typically called nanocapsules while capsules having an average particle size above 1 μm are typically called microcapsules.

The morphology of capsules and their preparation methods have been reviewed, for example, by Jyothi Sri. S in the International Journal of Pharma and Bio Sciences (Vol. 3, Issue 1, January-March 2012).

The capsules may have different morphologies, dependent on the preparation method of the capsules. For example mononuclear capsules have a shell around a core while polynuclear capsules have multiple cores enclosed within the shell. Matrix encapsulation refers to a core material which is homogeneously distributed into the shell.

Hydrophilic polymers, surfactants and/or polymeric dispersants may be used to obtain stable dispersions of the capsules in an aqueous medium and to control the particle size and the particle size distribution of the capsules.

In a preferred embodiment, the capsules are dispersed in the aqueous medium using a dispersing group covalently bonded to the polymeric shell. The dispersing group is preferably selected from a group consisting of a carboxylic acid or salt thereof, a sulfonic acid or salt thereof, a phosphoric acid ester or salt thereof, a phosphonic acid or salt thereof, an ammonium group, a sulfonium group, a phosphonium group and a polyethylene oxide group.

The dispersing groups stabilize the aqueous dispersion by electrostatic stabilization. For example, a slightly alkaline aqueous medium will turn the carboxylic acid groups covalently bonded to the polymeric shell into ionic groups, whereafter the negatively charged capsules have no tendency to agglomerate. If sufficient dispersing groups are covalently bonded to the polymeric shell, the capsule becomes a so-called self-dispersing capsule. Other dispersing groups such as sulfonic acid groups tend to be dissociated even in acid aqueous medium and thus do not require the addition of an alkali.

The dispersing group can be used in combination with a polymeric dispersant in order to accomplish steric stabilization. For example, the polymeric shell may have covalently bonded carboxylic acid groups that interact with amine groups of a polymeric dispersant. However, in a more preferred embodiment, no polymeric dispersant is used and dispersion stability is accomplished solely by electrostatic stabilization.

The capsules may also be stabilized by solid particles which adsorb onto the shell. Preferred solid particles are colloidal silica.

There is no real limitation on the type of polymer used for the polymeric shell of the capsule. Preferably, the polymer used in the polymeric shell is crosslinked. By crosslinking, more rigidity is built into the capsules allowing a broader range of temperatures and pressures for handling the colour laser markable article.

Preferred examples of the polymeric shell material include polyureas, polyacrylates, polymethacrylates, polyurethanes, polyesters, polycarbonates, polyamides, melamine based polymers and mixtures thereof, with polyureas and polyurethanes being especially preferred.

Capsules can be prepared using both chemical and physical methods. Suitable encapsulation methodologies include complex coacervation, liposome formation, spray drying and polymerization methods.

In the present invention, preferably a polymerization method is used as it allows the highest control in designing the capsules. More preferably interfacial polymerization is used to prepare the capsules used in the invention. This technique is well-known and has recently been reviewed by Zhang Y. and Rochefort D. (Journal of Microencapsulation, 29(7), 636-649 (2012) and by Salitin (in Encapsulation Nanotechnologies, Vikas Mittal (ed.), chapter 5, 137-173 (Scrivener Publishing LLC (2013)).

Interfacial polymerization is a particularly preferred technology for the preparation of capsules according to the present invention. In interfacial polymerization, such as interfacial polycondensation, two reactants meet at the interface of the emulsion droplets and react rapidly.

In general, interfacial polymerization requires the dispersion of an oleophilic phase in an aqueous continuous phase or vice versa. Each of the phases contains at least one dissolved monomer (a first shell component) that is capable of reacting with another monomer (a second shell component) dissolved in the other phase. Upon polymerisation, a polymer is formed that is insoluble in both the aqueous and the oleophilic phase. As a result, the formed polymer has a tendency to precipitate at the interface of the oleophilic and aqueous phase, hereby forming a shell around the dispersed phase, which grows upon further polymerization. The capsules according to the present invention are preferably prepared from an oleophilic dispersion in an aqueous continuous phase.

Typical polymeric shells, formed by interfacial polymerization are selected from the group consisting of polyamides, typically prepared from di- or oligoamines as first shell component and di- or poly-acid chlorides as second shell component; polyurea, typically prepared from di- or oligoamines as first shell component and di- or oligoisocyanates as second shell component; polyurethanes, typically prepared from di- or oligoalcohols as first shell component and di- or oligoisocyanates as second shell component; polysulfonamides, typically prepared from di- or oligoamines as first shell component and di- or oligosulfochlorides as second shell component; polyesters, typically prepared from di- or oligoalcohols as first shell component and di- or oligo-acid chlorides as second shell component; and polycarbonates, typically prepared from di- or oligoalcohols as first shell component and di- or oligo-chloroformates as second shell component. The shell can be composed of combinations of these polymers.

In a further embodiment, polymers, such as gelatine, chitosan, albumin and polyethylene imine can be used as first shell components in combination with a di- or oligo-isocyanate, a di- or oligo acid chloride, a di- or oligo-chloroformate and an epoxy resin as second shell component.

In a particularly preferred embodiment, the shell is composed of a polyurethane, a polyurea or a combination thereof.

In a further preferred embodiment, a water immiscible solvent is used in the dispersion step, which is removed by solvent stripping before or after the shell formation. In a particularly preferred embodiment, the water immiscible solvent has a boiling point below 100° C. at normal pressure. Esters are particularly preferred as water immiscible solvent. A preferred organic solvent is ethyl acetate, because it also has a low flammability hazard compared to other organic solvents.

A water immiscible solvent is an organic solvent having low miscibility in water. Low miscibility is defined as any water solvent combination forming a two phase system at 20° C. when mixed in a one over one volume ratio.

The method for preparing a dispersion of capsules preferably includes the following steps:

a) preparing a non-aqueous solution of a first shell component for forming a polymeric shell, a leuco dye, and optionally a water immiscible organic solvent having a lower boiling point than water;
b) preparing an aqueous solution of a second shell component for forming the polymeric shell;
c) dispersing the non-aqueous solution under high shear in the aqueous solution;
d) optionally stripping the water immiscible organic solvent from the mixture of the aqueous solution and the non-aqueous solution; and
e) preparing the polymeric shell around the leuco dye by interfacial polymerization of the first and second shell components for forming the polymeric shell.

An optothermal converting agent may be added together with the leuco dye in step (a) to the non-aqueous solution resulting in capsules wherein both the leuco dye and the optothermal converting agent are located in the core of the capsule.

A colour developing agent or colour developing agent precursor is preferably separately encapsulated. In a preferred embodiment, the laser markable composition comprises a first capsule containing a leuco dye and an optional optothermal converting agent in its core and a second capsule containing a colour developing agent or colour developing agent precursor in its core.

The capsules may contain two, three or more different leuco dyes in order to optimize the colour obtained upon heat treatment.

### Polymeric Leuco Dyes

A leuco dye may also become diffusion hindered by polymerizing or co-polymerizing the leuco dye to form a polymeric leuco dye or by post derivation of a polymeric resin with the leuco dye.

Typical polymeric leuco dyes obtained by copolymerizing a polymerisable leuco dye with other monomers, represented by the comonomers, are given in Table 1 without being limited thereto.

TABLE 1

| | | | |
|---|---|---|---|
| 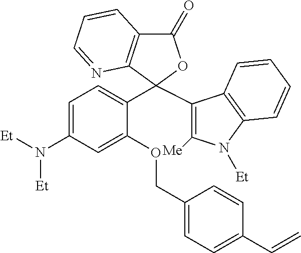 [SMILES: C=Cc1ccc(COc2cc(N(CC)CC)ccc2C2(c3c(C)n(CC)c4ccccc34)OC(=O)c3cccnc32)cc1] | 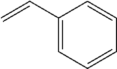 | 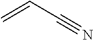 | Polyleuco-1 |
| 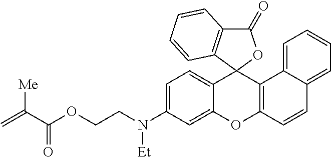 [SMILES: C=C(C)C(=O)OCCN(CC)c1ccc2c(c1)Oc1ccc3ccccc3c1C21OC(=O)c2ccccc21] | 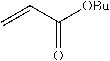 | | Polyleuco-2 |
| 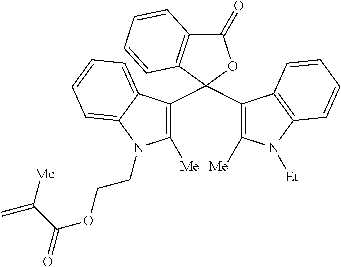 [SMILES: C=C(C)C(=O)OCCn1c(C)c(C2(c3c(C)n(CC)c4ccccc34)OC(=O)c3ccccc32)c2ccccc21] | 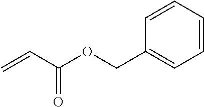 | | Polyleuco-3 |
| 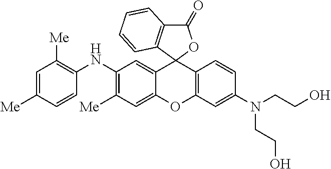 [SMILES: Cc1ccc(Nc2cc3c(cc2C)Oc2cc(N(CCO)CCO)ccc2C32OC(=O)c3ccccc32)c(C)c1] | 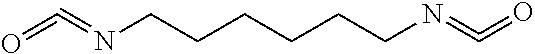 [SMILES: O=C=NCCCCCCN=C=O] | | Polyleuco-4 |
| 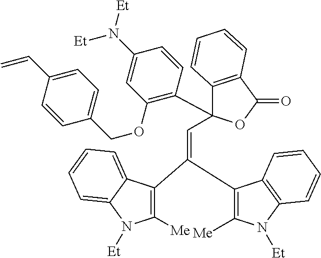 [SMILES: C=Cc1ccc(COc2cc(N(CC)CC)ccc2C2(C=C(c3c(C)n(CC)c4ccccc34)c3c(C)n(CC)c4ccccc34)OC(=O)c3ccccc32)cc1] | 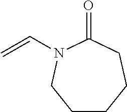 | 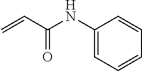 | Polyleuco-5 |
| 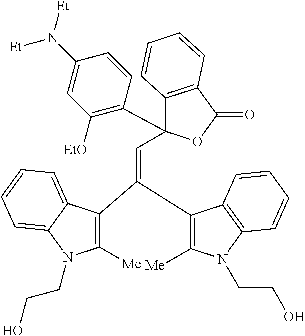 [SMILES: CCOc1cc(N(CC)CC)ccc1C1(C=C(c2c(C)n(CCO)c3ccccc23)c2c(C)n(CCO)c3ccccc23)OC(=O)c2ccccc21] | 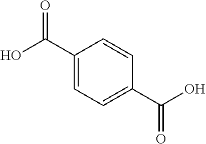 [SMILES: O=C(O)c1ccc(C(=O)O)cc1] | | Polyleuco-6 |

When the laser markable composition is an aqueous composition, the polymeric leuco dye is preferably added to the composition as polymeric particles dispersed in water, also referred to as a latex.

The polymer particles have an average particle diameter measured by dynamic laser diffraction of from 10 nm to 800 nm, preferably from 15 to 350 nm, more preferably from 20 to 150 nm, most preferably from 25 nm to 100 nm.

In a preferred embodiment of the invention, the polymer particle is a copolymer comprising a monomeric unit containing a leuco dye. The monomer containing the leuco dye is preferably used in combination with other monomers selected from the group consisting of ethylene, vinylchloride, methylacrylate, methylmethacrylate ethylacrylate, ethylmethacrylate, vinylidene chloride, acrylonitrile, methacrylonitrile, vinylcarbazole, or styrene.

The amount of monomers containing a leuco dye relative to the total weight of the polymer particles is preferably between 2 and 30 wt %, more preferably between 5 and 15 wt %. The amount of monomers containing a leuco dye is typically optimized in order to obtain sufficient colour formation upon exposure to heat or IR radiation.

The polymeric leuco dyes may be obtained through a radical (co)-polymerization or through a condensation reaction.

The polymer particles are preferably prepared by an emulsion polymerization. Emulsion polymerization is typically carried out through controlled addition of several components—i.e. vinyl monomers, surfactants (dispersion aids), initiators and optionally other components such as buffers or protective colloids—to a continuous medium, usually water. The resulting polymer of the emulsion polymerization is a dispersion of discrete particles in water. The surfactants or dispersion aids which are present in the reaction medium have a multiple role in the emulsion polymerization: (1) they reduce the interfacial tension between the monomers and the aqueous phase, (2) they provide reaction sites through micelle formation in which the polymerization occurs and (3) they stabilize the growing polymer particles and ultimately the latex emulsion. The surfactants are adsorbed at the water/polymer interface and thereby prevent coagulation of the fine polymer particles. A wide variety of surfactants are used for the emulsion polymerisation. In general, a surfactant molecule contains both polar (hydrophilic) and non-polar (hydrophobic or lipophilic) groups. The most used surfactants are anionic or non-ionic surfactants. Widely used anionic surfactants are, alkylsulfates, alkyl ether sulfates, alkyl ether carboxylates, alkyl or aryl sulfonates, alkyl phosphates or alkyl ether phosphates. An example of an alkyl sulfate surfactant is sodium lauryl sulfate (e.g. Texapon K12 by the company Cognis). An example of an alkyl ether sulfate surfactant is laureth-2 sulfate sodium salt (e.g. Empicol ESB form the company Huntsman). An example of an alkyl ether carboxylate is laureth-6 carboxylate (e.g. Akypo RLM45 from the company Kao Chemicals). An example of an alkyl ether phosphate is Trideceth-3 phosphate ester (e.g. Chemfac PB-133 from the company Chemax Inc.).

The critical micelle concentration (C.M.C.) of the used surfactants is an important property to control the particle nucleation and consequently the particle size and stabilization of the polymer particles. The C.M.C. can be varied by variation of the degree of ethoxylation of the surfactant. Alkyl ether sulfates having a different degree of ethoxylation are for example Empicol ESA (Laurette-1 sulfate sodium salt), Empicol ESB (Laurette-2 sulfate sodium salt) and Empicol ESC (Laurette-3 sulfate sodium salt). Alkyl ether carboxylates having a different degree of ethoxylation are for example Akypo RLM-25 (Laurette-4 carboxylic acid), Akypo RLM-45 (Laurette-6 carboxylic acid) and Akypo RLM-70 (Laurette-8 carboxylic acid). Alkyl ether phosphates having a different degree of ethoxylation are for example Chemfac

PB-133 (Trideceth-3 phosphate ester, acid form), Chemfac PB-136 (Trideceth-6-phosphate ester, acid form) and Chemfac PB-139 (Trideceth-9-phosphate ester, acid form).

The carboxylate and phosphate ester surfactants are usually supplied in the acid form. In order to prepare an aqueous solution of these surfactants, a base such as NaOH, Na₂CO₃, NaHCO₃, NH₄OH, or NH₄HCO₃ must be added.

In a preferred embodiment, the polymer particles are prepared by emulsion polymerization in the presence of a surfactant selected from alkyl phosphates and alkyl ether phosphates.

Another preferred method of preparing the polymer particles is the so-called mini-emulsion polymerization method as described for example by TANG et al. in Journal of Applied Polymer Science, Volume 43, pages 1059-1066 (1991) and by Blythe et al. in Macromolecules, 1999, 32, 6944-6951.

Instead of using surfactants to stabilize the polymer particles, self-dispersible polymer particles may also be used. In preparing self-dispersing polymer particles, preferably a monomer is used selected from the group consisting of a carboxylic acid monomer, a sulfonic acid monomer, and a phosphoric acid monomer.

Specific examples of the unsaturated carboxylic acid monomer include acrylic acid, methacrylic acid, crotonic acid, itaconic acid, maleic acid, fumaric acid, citraconic acid, and 2-methacryloyloxy methylsuccinic acid. Specific examples of the unsaturated sulfonic acid monomer include styrene sulfonic acid, 2-acrylamido-2-methyl propane sulfonic acid, 3-sulfopropyl (meth)acrylate, and bis-(3-sulfopropyl)-itaconate. Specific examples of the unsaturated phosphoric acid monomer include vinyl phosphoric acid, vinyl phosphate, and bis(methacryloxyethyl)phosphate. Such monomers may be incorporated into polyurethane copolymers which include a (meth)acrylate polymeric chain.

Besides traditional emulsion polymerization wherein nucleation, i.e. initiation of the polymerization, is done via micellar or homogeneous nucleation, the so-called mini-emulsion polymerization, may also be used to prepare the polymer particles. In emulsion polymerization, the nucleation occurs in the monomer droplet. See for example “Emulsion Polymerization and Emulsion Polymers”, edited by Peter A. Lovell and Mohamed S. El-AASSER, 1997, page 42-43, wherein the different types of emulsion polymerization are described in more detail.

A mini-emulsion polymerization method is described in for example by TANG et al. in Journal of Applied Polymer Science, Volume 43, pages 1059-1066 (1991) and by Blythe et al. in Macromolecules, 1999, 32, 6944-6951.

Instead of using a monomer containing a leuco dye in a co-polymerization reaction to form the polymer particles,

Polymeric leuco dyes may also be obtained by post-derivatisation of a polymer resin. A leuco dye may also be covalently bonded to a already formed polymer particle, when reactive groups are present on the polymer particles which can react with a reactive leuco dye. To increase the efficiency of such a reaction, the reactive leuco dye may be added in a solvent which swells the polymer particles. That solvent may then be subsequently evaporated.

Examples of oligomeric and polymeric leuco dyes accessible using post derivatisation of polymeric resins as synthetic strategy are given in Table 2 without being limited thereto.

TABLE 2

| | |
|---|---|
| 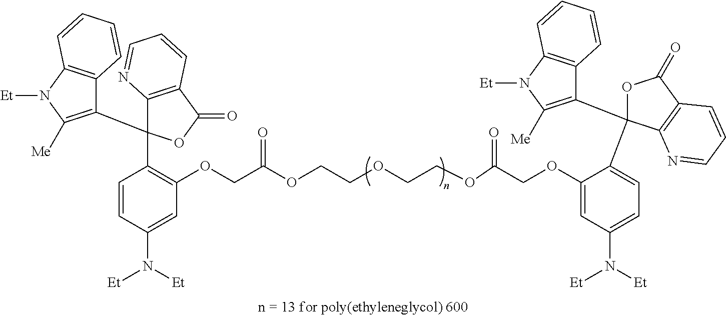 | Polyleuco-7 |
| 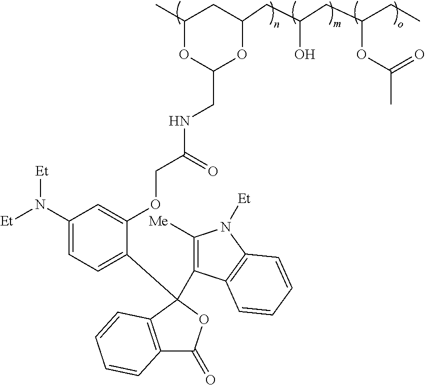 | Polyleuco-8 |

### Multifunctional Leuco Dyes

According to another embodiment, a leuco dye may become diffusion hindered by linking two or more basic leuco dyes to each other whereby the total molecular weight becomes at least twice the molecular weight of the basic leuco dye with the proviso that the total molecular weight is at least 500, more preferably at least 750 and most preferably at least 1000.

Typical di- and multifunctional leuco dyes are given in Table 3 without being limited thereto.

TABLE 3

| | |
|---|---|
| 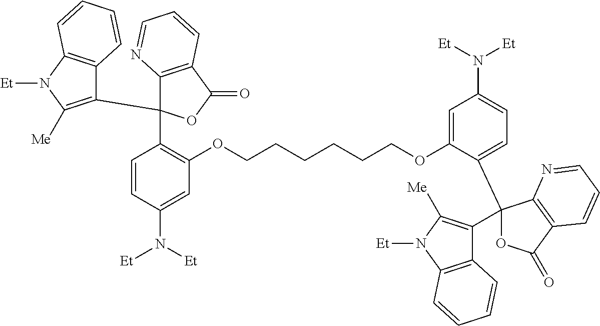 [SMILES: CCN(CC)c1ccc(C2(c3c(C)n(CC)c4ccccc34)OC(=O)c3cccnc32)c(OCCCCCCOc2cc(N(CC)CC)ccc2C2(c3c(C)n(CC)c4ccccc34)OC(=O)c3cccnc32)c1] | Multileuco-1 |
| 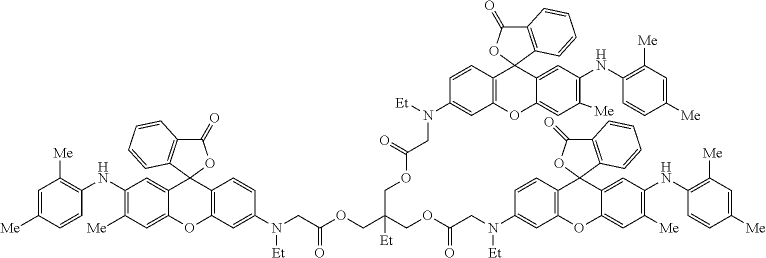 [SMILES: CCN(CC(=O)OCC(CC)(COC(=O)CN(CC)c1ccc2c(c1)Oc1cc(C)c(Nc3ccc(C)cc3C)cc1C21OC(=O)c2ccccc21)COC(=O)CN(CC)c1ccc2c(c1)Oc1cc(C)c(Nc3ccc(C)cc3C)cc1C21OC(=O)c2ccccc21)c1ccc2c(c1)Oc1cc(C)c(Nc3ccc(C)cc3C)cc1C21OC(=O)c2ccccc21] | Multileuco-2 |
| 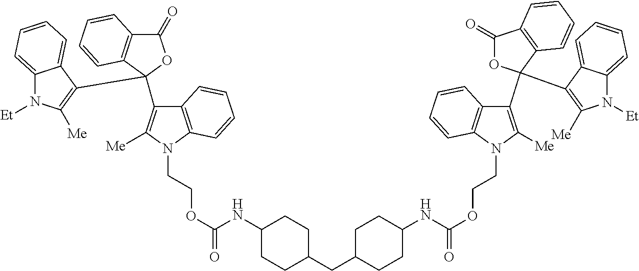 [SMILES: CCn1c(C)c(C2(c3c(C)n(CCOC(=O)NC4CCC(CC5CCC(NC(=O)OCCn6c(C)c(C7(c8c(C)n(CC)c9ccccc89)OC(=O)c8ccccc87)c7ccccc76)CC5)CC4)c4ccccc34)OC(=O)c3ccccc32)c2ccccc21] | Multileuco-3 |

### Polymerisable Leuco Dyes

In the embodiment wherein a UV curable composition, for example a UV curable inkjet ink, a polymerisable leuco dye is preferably used. Preferably, the leuco dye has two polymerisable groups.

Upon UV curing the composition, the leuco dyes are copolymerized together with the other monomers of the composition. As part of the resulting polymeric network, the leuco dyes also become diffusion hindered.

Typical polymerisable leuco dyes are given in Table 4 without being limited thereto.

TABLE 4

| | |
|---|---|
| 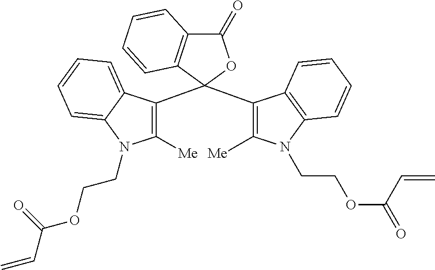 [SMILES: C=CC(=O)OCCn1c(C)c(C2(c3c(C)n(CCOC(=O)C=C)c4ccccc34)OC(=O)c3ccccc32)c2ccccc21] | Monoleuco-1 |
| 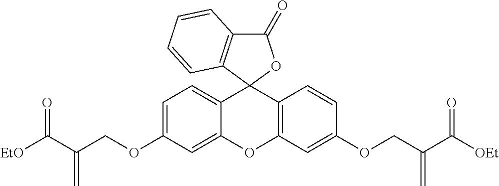 [SMILES: C=C(COc1ccc2c(c1)Oc1cc(OCC(=C)C(=O)OCC)ccc1C21OC(=O)c2ccccc21)C(=O)OCC] | Monoleuco-2 |
| 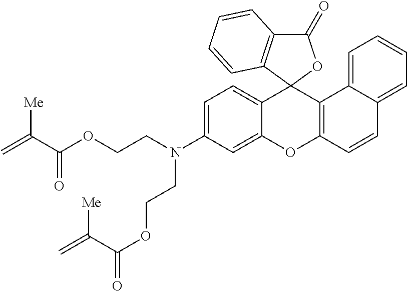 [SMILES: C=C(C)C(=O)OCCN(CCOC(=O)C(=C)C)c1ccc2c(c1)Oc1ccc3ccccc3c1C21OC(=O)c2ccccc21] | Monoleuco-3 |
| 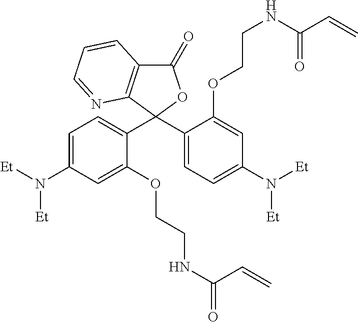 [SMILES: C=CC(=O)NCCOc1cc(N(CC)CC)ccc1C1(c2ccc(N(CC)CC)cc2OCCNC(=O)C=C)OC(=O)c2cccnc21] | Monoleuco-4 |
| 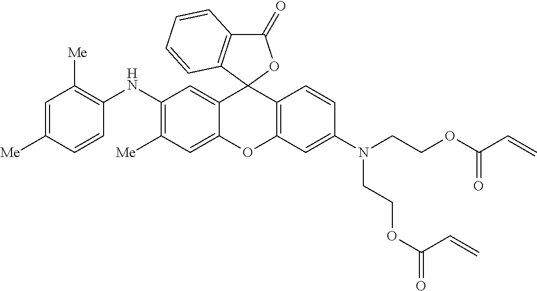 [SMILES: C=CC(=O)OCCN(CCOC(=O)C=C)c1ccc2c(c1)Oc1cc(C)c(Nc3ccc(C)cc3C)cc1C21OC(=O)c2ccccc21] | Monoleuco-5 |
| 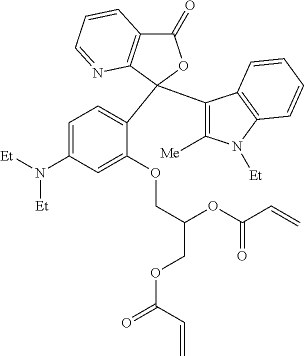 [SMILES: C=CC(=O)OCC(COc1cc(N(CC)CC)ccc1C1(c2c(C)n(CC)c3ccccc23)OC(=O)c2cccnc21)OC(=O)C=C] | Monoleuco-6 |
| 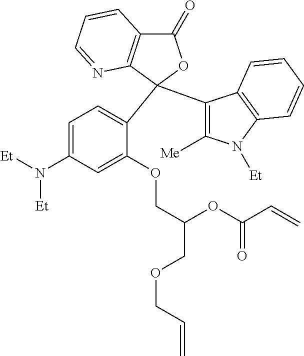 [SMILES: C=CCOCC(COc1cc(N(CC)CC)ccc1C1(c2c(C)n(CC)c3ccccc23)OC(=O)c2cccnc21)OC(=O)C=C] | Monoleuco-7 |
| 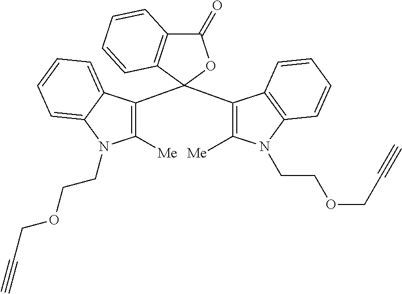 [SMILES: C#CCOCCn1c(C)c(C2(c3c(C)n(CCOCC#C)c4ccccc34)OC(=O)c3ccccc32)c2ccccc21] | Monoleuco-8 |
| 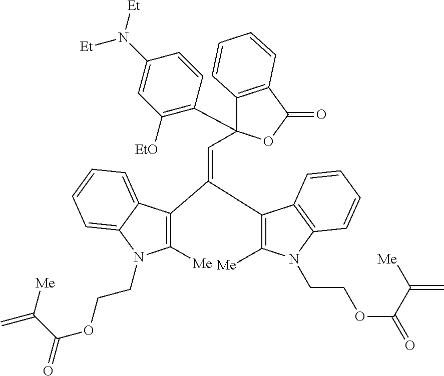 [SMILES: C=C(C)C(=O)OCCn1c(C)c(C(=CC2(c3ccc(N(CC)CC)cc3OCC)OC(=O)c3ccccc32)c2c(C)n(CCOC(=O)C(=C)C)c3ccccc23)c2ccccc21] | Monoleuco-9 |

### Colour Developing Agent

A colour developing agent is capable of reacting with a colourless leuco dye resulting in the formation of a coloured dye.

Various electron accepting substances may be used as colour developing agent in the present invention. Examples thereof include phenolic compounds, organic or inorganic acidic compounds and esters or salts thereof.

Specific examples include bisphenol A; tetrabromobisphenol A; gallic acid; salicylic acid; 3-isopropyl salicylate; 3-cyclohexyl salicylate; 3-5-di-tert-butyl salicylate; 3,5-di-α-methyl benzyl salicylate; 4,4′-isopropylidenediphenol; 1,1′-isopropylidene bis(2-chlorophenol); 4,4′-isopropylene bis(2,6-dibromo-phenol); 4,4′-isopropylidene bis(2,6-dichlorophenol); 4,4′-isopropylidene bis(2-methyl phenol); 4,4′-isopropylidene bis(2,6-dimethyl phenol); 4,4′-isopropylidene bis(2-tert-butyl phenol); 4,4′-sec-butylidene diphenol; 4,4′-cyclohexylidene bisphenol; 4,4′-cyclohexylidene bis(2-methyl phenol); 4-tert-butyl phenol; 4-phenyl phenol; 4-hydroxy diphenoxide; α-naphthol; β-naphthol; 3,5-xylenol; thymol; methyl-4-hydroxybenzoate; 4-hydroxy-acetophenone; novolak phenol resins; 2,2′-thio bis(4,6-dichloro phenol); catechol; resorcin; hydroquinone; pyrogallol; fluoroglycine; fluoroglycine carboxylate; 4-tert-octyl catechol; 2,2′-methylene bis(4-chlorophenol); 2,2′-methylene bis(4-methyl-6-tert-butyl phenol); 2,2′-dihydroxy diphenyl; ethyl p-hydroxybenzoate; propyl p-hydroxybenzoate; butyl p-hydroxy-benzoate; benzyl p-hydroxybenzoate; p-hydroxybenzoate-p-chlorobenzyl; p-hydroxybenzoate-o-chlorobenzyl; p-hydroxybenzoate-p-methylbenzyl; p-hydroxybenzoate-n-octyl; benzoic acid; zinc salicylate; 1-hydroxy-2-naphthoic acid; 2-hydroxy-6-naphthoic acid; 2-hydroxy-6-zinc naphthoate; 4-hydroxy diphenyl sulphone; 4-hydroxy-4′-chloro diphenyl sulfone; bis(4-hydroxy phenyl)sulphide; 2-hydroxy-p-toluic acid; 3,5-di-tert-zinc butyl salicylate; 3,5-di-tert-tin butyl salicylate; tartaric acid; oxalic acid; maleic acid; citric acid; succinic acid; stearic acid; 4-hydroxyphthalic acid; boric acid; thiourea derivatives; 4-hydroxy thiophenol derivatives; bis(4-hydroxyphenyl) acetate; bis(4-hydroxyphenyl)ethyl acetate; bis(4-hydroxyphenyl)acetate-n-propyl; bis(4-hydroxy-phenyl)acetate-n-butyl; bis(4-hydroxyphenyl)phenyl acetate; bis(4-hydroxyphenyl)-benzyl acetate; bis(4-hydroxyphenyl)phenethyl acetate; bis(3-methyl-4-hydroxy-phenyl)acetate; bis(3-methyl-4-hydroxy-phenyl)methyl acetate; bis(3-methyl-4-hydroxyphenyl)acetate-n-propyl; 1,7-bis(4-hydroxyphenylthio)3,5-dioxaheptane; 1,5-bis(4-hydroxy-phenylthio)3-oxaheptane; 4-hydroxy phthalate dimethyl; 4-hydroxy-4′-methoxy diphenyl sulfone; 4-hydroxy-4′-ethoxy diphenyl sulfone; 4-hydroxy-4′-isopropoxy diphenyl sulfone; 4-hydroxy-4′-propoxy diphenyl sulfone; 4-hydroxy-4′-butoxy diphenyl sulfone; 4-hydroxy-4′-isopropoxy diphenyl sulfone; 4-hydroxy-4′-sec-butoxy diphenyl sulfone; 4-hydroxy-4′-tert-butoxy diphenyl sulfone; 4-hydroxy-4′-benzyloxy diphenyl sulfone; 4-hydroxy-4′-phenoxy diphenyl sulfone; 4-hydroxy-4′-(m-methyl benzoxy)diphenyl sulfone; 4-hydroxy-4′-(p-methyl benzoxy)diphenyl sulfone; 4-hydroxy-4′-(o-methyl benzoxy)diphenyl sulfone; 4-hydroxy-4′-(p-chloro benzoxy)diphenyl sulfone and 4-hydroxy-4′-oxyaryl diphenyl sulfone.

A preferred colour developing agent is a metal salt of salicylate, for example zinc salicylate. A particularly preferred colour developing agent is zinc 3,5-bis(α-methylbenzyl) salicylate.

### Colour Developing Agent Precursor

Also a so-called colour developing agent precursor may be used. Such a precursor forms a colour developing agent upon exposure to heat. Using a colour developing agent precursor instead of a colour developer may result in a better UV and heat stability of the laser markable composition.

The colour developing agent precursor may be present in the continuous phase of the laser markable composition or it may be present in the core of a capsule. However, when the colour developing agent is not, or slightly, soluble in aqueous media, it is preferred to add such a colour developing agent as an aqueous dispersion or emulsion.

All publicly-known thermal acid generators can be used as colour developing agent. Thermal acid generators are for example widely used in conventional photoresist material. For more information see for example Encyclopaedia of polymer science”, 4th edition, Wiley or “Industrial Photoinitiators, A Technical Guide”, CRC Press 2010.

Preferred classes of photo- and thermal acid generators are iodonium salts, sulfonium salts, ferrocenium salts, sulfonyl oximes, halomethyl triazines, halomethylarylsulfone, α-haloacetophenones, sulfonate esters, t-butyl esters, allyl substituted phenols, t-butyl carbonates, sulfate esters, phosphate esters and phosphonate esters.

Preferred thermal acid generating compounds have a structure according to Formula (I) or Formula (II):

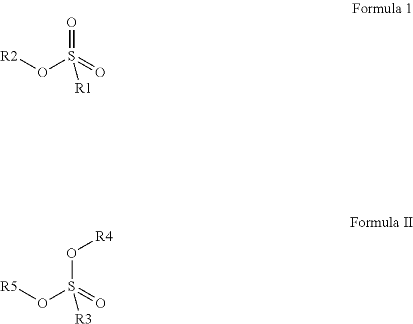

wherein
R1 and R3 independently represent an optionally substituted alkyl group, an optionally substituted (hetero)cyclic alkyl group, an optionally substituted alkanyl group, an optionally substituted alkenyl group, an optionally substituted alkynyl group, an optionally substituted (hetero)aryl group, an optionally substituted aralkyl group, an optionally substituted alkoxy group, an optionally substituted (hetero)cyclic alkoxy group, or an optionally substituted (hetero)aryloxy group. R2, R4 and R5 independently represent an optionally substituted alkyl, an optionally substituted aliphatic (hetero)cyclic alkyl group or an optionally substituted aralkyl group; R1 and R2, R4 and R5, R3 and R4, and R3 and R5 may represent the necessary atoms to form a ring.

Suitable alkyl groups include 1 or more carbon atoms such as for example C₁ to C₂₂-alkyl groups, more preferably C₁ to C₁₂-alkyl groups and most preferably C₁ to C₆-alkyl groups. The alkyl group may be linear or branched such as for example methyl, ethyl, propyl (n-propyl, isopropyl), butyl (n-butyl, isobutyl, t-butyl), pentyl, 1,1-dimethyl-propyl, 2,2-dimethylpropyl and 2-methyl-butyl, or hexyl.

Suitable cyclic alkyl groups include cyclopentyl, cyclohexyl or adamantyl.

Suitable heterocyclic alkyl groups include tetrahydrofuryl, piperidinyl, pyrrolidinyl, dioxyl, tetrahydrothiophenyl, silolanyl, or thianyl oxanyl.

Suitable aryl groups include for example phenyl, naphthyl, benzyl, tolyl, ortho-meta- or para-xylyl, anthracenyl or phenanthrenyl.

Suitable heteroaryl groups include monocyclic- or polycyclic aromatic rings comprising carbon atoms and one or more heteroatoms in the ring structure. Preferably 1 to 4 heteroatoms independently selected from nitrogen, oxygen, selenium and sulphur and/or combinations thereof. Examples include pyridyl, pyrimidyl, pyrazoyl, triazinyl, imidazolyl, (1,2,3,)- and (1,2,4)-triazolyl, tetrazolyl, furyl, thienyl, isoxazolyl, thiazolyl and carbazoyl.

Suitable alkoxy groups include those containing from 1 to 18, preferably 2 to 8 carbon atoms, such as ethoxide, propoxide, isopropoxide, butoxide, isobutoxide and tert-butoxide.

Suitable aryloxy groups include phenoxy and naphthoxy.

The alkyl, (hetero)cyclic alkyl, aralkyl, (hetero)aryl, alkoxy, (hetero)cyclic alkoxy, or (hetero)aryloxy groups may include one or more substituents. The optional substituents are preferably selected from an alkyl group such as a methyl, ethyl, n-propyl, isopropyl, n-butyl, 1-isobutyl, 2-isobutyl and tertiary-butyl group; an ester, amide, ether, thioether, ketone, aldehyde, sulfoxide, sulfone, sulfonate ester or sulfonamide group, a halogen such as fluorine, chlorine, bromine or iodine, —OH, —SH, —CN and —NO₂, and/or combinations thereof.

R1 preferably represents a C₁ to C₂₂-alkyl group, an aliphatic alkoxide group containing 2 to 8 carbons, a phenyl group or a tolyl group. R1 most preferably represents a tolyl group.

R2 preferably represents a C₁ to C₂₂-alkyl group or a (hetero)cyclic alkyl group. R2 most preferably represents a cyclohexyl group.

R3 preferably represents a C₁ to C₂₂-alkyl group, an aliphatic alkoxide group containing 2 to 8 carbons or a benzyl group.

In a preferred embodiment, R4 and R5 independently represent a C₁ to C₂₂-alkyl group. In a preferred embodiment, R4 and R5 represent independently an isobutyl, t-butyl, isopropyl, 2-ethylhexyl or a linear C₂ to C₈-alkyl group.

The compound used in the present invention can be a monomer, an oligomer (i.e. a structure including a limited amount of monomers such as two, three or four repeating units) or a polymer (i.e. a structure including more than four repeating units).

The compound used in the present invention contains at least one moiety according to Formula I and/or Formula II, preferably 1 to 150 moieties according to Formula I and/or Formula II. According to a preferred embodiment, the compound according to Formula I or Formula II may be present in a side chain of a polymer.

In the embodiment wherein the compound according to Formula I or Formula II is present in the side chain of a polymer, the following moiety (Formula III, IV or V) is preferably attached to the polymer:

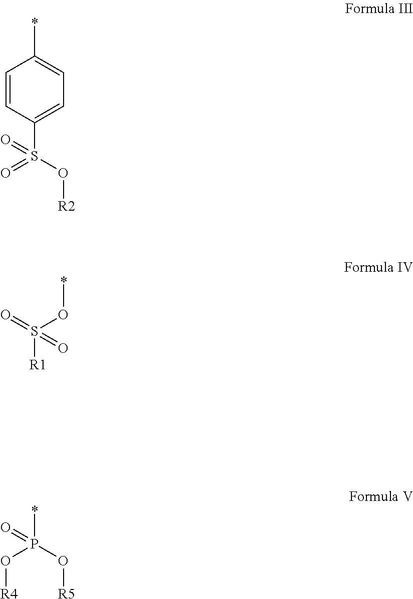

wherein

* denotes the linking to the polymer and

R1, R2, R4 and R5 as described above.

In the embodiment wherein the compound according to Formula I is present in the side chain of a polymer, the polymer is more preferably obtained from the coupling of a polymer or copolymer bearing side chains with alcohol groups and a sulfonyl chloride.

In the embodiment wherein the compound according to Formula I is present in the side chain of a polymer, the polymer is most preferably obtained from the coupling of a polymer or copolymer bearing side chains with alcohol groups and tosyl chloride. Useful polymers bearing side chains with alcohol include for example polyvinyl alcohol, polyvinyl butyral, cellulose derivatives, homo- and copolymers of 2-hydroxyethyl methacrylate, 2-hydroxyethyl acrylate, polysiloxane derivatives such as copolymers of hydroxyalkyl-methylsiloxane, and novolac resins.

Examples of acid generating compounds according to the present invention are shown in Table 5.

TABLE 5

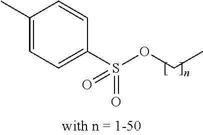

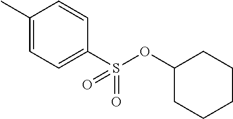 [SMILES: Cc1ccc(S(=O)(=O)OC2CCCCC2)cc1]

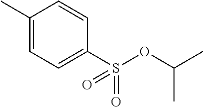

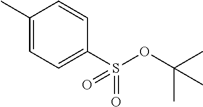

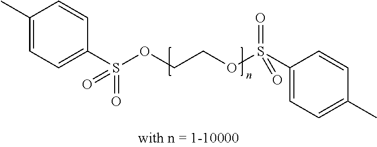

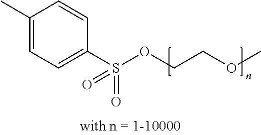

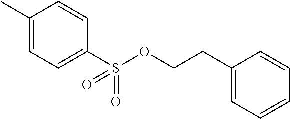 [SMILES: Cc1ccc(S(=O)(=O)OCCc2ccccc2)cc1]

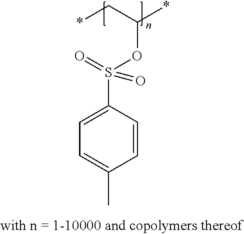

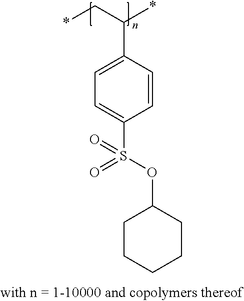

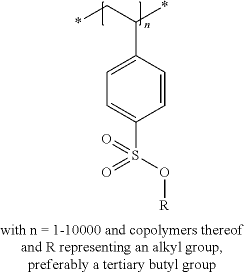

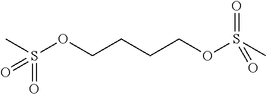

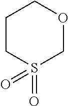

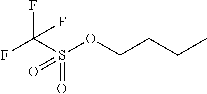

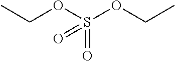

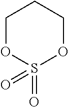

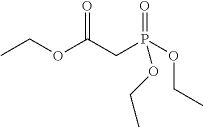

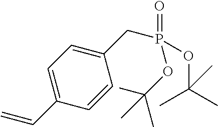 [SMILES: C=Cc1ccc(CP(=O)(OC(C)(C)C)OC(C)(C)C)cc1]

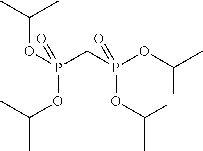 [SMILES: CC(C)OP(=O)(CP(=O)(OC(C)C)OC(C)C)OC(C)C]

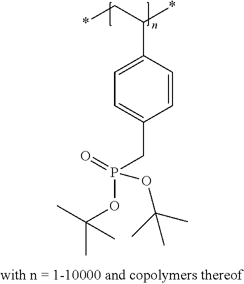

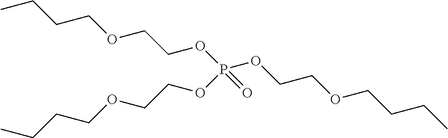 [SMILES: CCCCOCCOP(=O)(OCCOCCCC)OCCOCCCC]

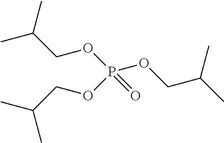 [SMILES: CC(C)COP(=O)(OCC(C)C)OCC(C)C]

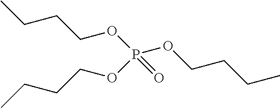 [SMILES: CCCCOP(=O)(OCCCC)OCCCC]

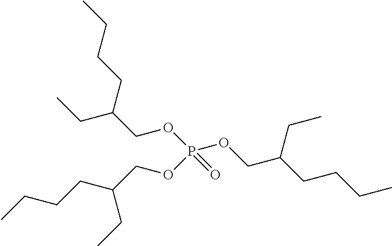 [SMILES: CCCCC(CC)COP(=O)(OCC(CC)CCCC)OCC(CC)CCCC]

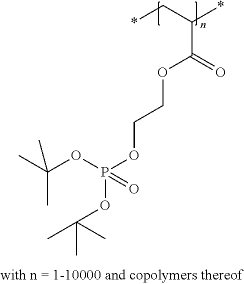

Other classes of photo- and thermal acid generators are iodonium salts, sulfonium salts, ferrocenium salts, sulfonyl oximes, halomethyl triazines, halomethyl-arylsulfone, α-haloacetophenones, sulfonate esters, t-butyl esters, allyl substituted phenols, t-butyl carbonates, sulfate esters, phosphate esters and phosphonate esters.

Colour developing agents or colour developing agent precursors may become “diffusion hindered” by:
including the colour developing agent or colour developing agent precursor in the core of a capsule composed of a polymeric shell surrounding a core;
polymerizing or co-polymerizing the colour developing agent or colour developing agent to form a polymeric colour developing agent or colour developing agent; or
linking two or more basic colour developing agent or colour developing agent precursor to each other whereby the total molecular weight of the resulting compound becomes at least twice the molecular weight of the basic ingredient with the proviso that the total molecular weight is at least 500, more preferably at least 750 and most preferably at least 1000.

By using a diffusion hindered colour developing agent or colour developing agent, the risk of penetrating through a food or pharmaceutical packaging is minimized. Furthermore, the leuco dye cannot be extracted by moisture, e.g. by sweaty hands, before heat treatment or verification of the authenticity of the packaging.

### Capsules

The colour developing agent or colour developing agent precursor may be become “diffusion hindered” by including the leuco dye in the core of a capsule composed of a polymeric shell surrounding a core.

The preparation and properties of such capsules are similar as for the capsules containing a leuco dye described above.

### Polymeric Colour Developing Agent or Colour Developing Agent Precursor

Colour developing agents or colour developing agents precursors may also become diffusion hindered by polymerizing or co-polymerizing the colour developing agent or colour developing agent precursor to form a polymeric leuco dye or by post derivation of a polymeric resin with the colour developing agent or colour developing agent precursor.

The preparation and the properties of the polymeric colour developing agent or colour developing agent precursor are similar as for the polymeric leuco dyes described above.

Typical polymeric and oligomeric colour developing agent or colour developing agent precursor are given in Table 6 without being limited thereto.

TABLE 6

| | |
|---|---|
| 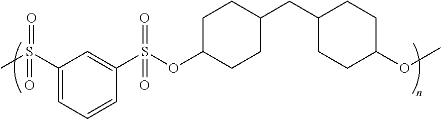 | Polydev-1 |
| 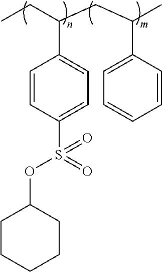 | Polydev-2 |
| 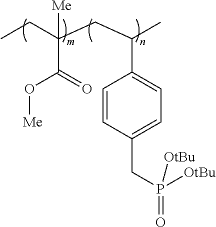 | Polydev-3 |
| 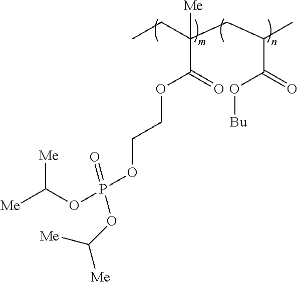 | Polydev-4 |
| 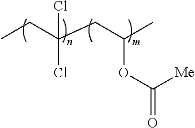 | Polydev-5 |
| 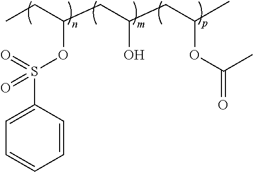 | Polydev-6 |
| 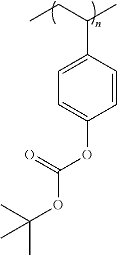 | Polydev-7 |
| 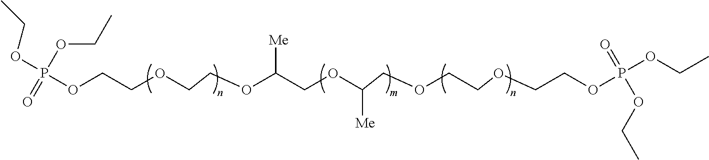 | Polydev-8 |

According to preferred embodiment of the invention, the colour developing agent precursor is a polymeric leuco dye capable of forming an acid upon exposure to heat.

The acid liberated upon exposure to heat within the meaning of the invention includes Arrhenius acids, Brønsted-Lowry acids, and Lewis acids.

The polymer particles comprise repeating units, which are capable of generating an acid upon exposure to heat. Typically, exposure to heat may cause a fragmentation reaction resulting in an acid formation. The resulting acid may be a low molecular weight molecule formed by the fragmentation reaction or the acid may reside on the polymer particle after a fragmentation reaction. Table 7 depicts (part of) polymeric acid precursors, more specific the repeating unit that is able to generate an acid upon thermal treatment.

TABLE 7

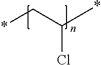

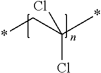

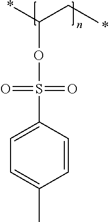

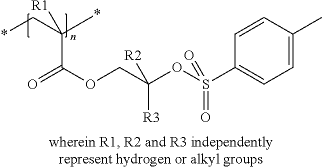

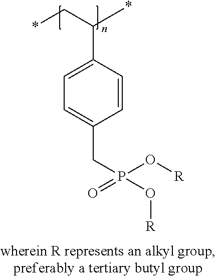

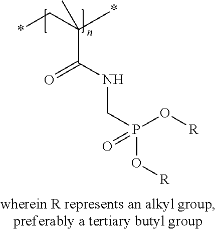

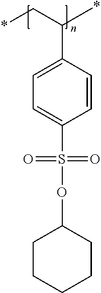

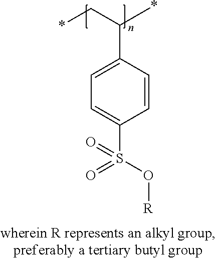

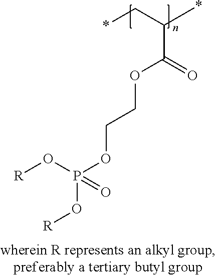

Preferred polymeric particles are capable of releasing a low molecular weight acid.

A particularly preferred polymer particle is a polyvinylidenechloride (PVDC) polymer particle. Upon exposure to heat, such a polymer particle is capable of releasing HCl.

The polyvinylidenechloride (PVDC) particle is preferably a vinylidene chloride copolymer comprising 90 wt % or less of vinylidene chloride based on the total weight of the binder.

When the amount of vinylidene chloride is above 90 wt % based on the total weight of the binder, the crystallinity of the binder becomes too high resulting in poor film forming property. Copolymerizaton of vinylidene chloride with further monomers renders the copolymer more amorphous and thus more soluble in the liquid carrier.

The vinylidene chloride copolymer preferably comprises a further monomer selected from the group consisting of vinyl chloride, alkyl acrylate, alkyl methacrylate, vinylether, vinylacetate, vinyl alcohol, acrylonitrile, methacrylonitrile, maleic acid, maleic anhydride, itaconic acid.

The vinylidene chloride copolymer more preferably comprises a further monomer selected from the group consisting of vinyl chloride, acrylonitrile, maleci acid, maleic anhydride and an alkyl acrylate.

The alkyl acrylate and alkyl methacrylate referred to above is preferably a C1-C10 alkyl acrylate or methacrylate. Particular preferred alkyl acrylates or alkyl methacrylates are methyl and butyl acrylate or methyl and butyl methacrylate.

Water based vinylidene copolymers may also be used in the present invention. Examples of such copolymers are Daran® 8730, Daran® 8550, Daran® SL112, Daran® SL143, Daran® SL159 or Daran® 8100, all commercially available from Owensboro Specialty Polymers; Diofan® 193D, Diofan® P520, Diofan® P530 all commercially available from Solvay.

A PVDC copolymer may be characterized by the so-called dehydrochlorination constant (DHC). The amount of HCl liberated by a specific PVDC copolymer at a specified temperature during a specific time is measured.

The amount of polymer particle in the laser markable composition is preferably between 5 and 75 wt %, more preferably between 7.5 and 50 wt %, most preferably between 10 and 40 wt %, relative to the total weight of the laser markable composition. After applying and drying the composition on a support, the amount of polymer particles is preferably between 50 and 95 wt %, more preferably between 65 and 90 wt %, most preferably between 75 and 85 wt %, relative to the total dry weight of the laser markable composition.

### Multifunctional Colour Developing Agents or Colour Developing Agent Precursors.

According to another embodiment, a colour developing agent or colour developing agent precursor may become diffusion hindered by linking two or more basic colour developing agent or colour developing agent precursor to each other whereby the total molecular weight becomes at least twice the molecular weight of the basic leuco dye with the proviso that the total molecular weight is at least 500, more preferably at least 750 and most preferably at least 1000.

Typical di- and multifunctional colour developing agent or colour developing agent precursor are given in Table 8 without being limited thereto.

TABLE 8

| | |
|---|---|
| 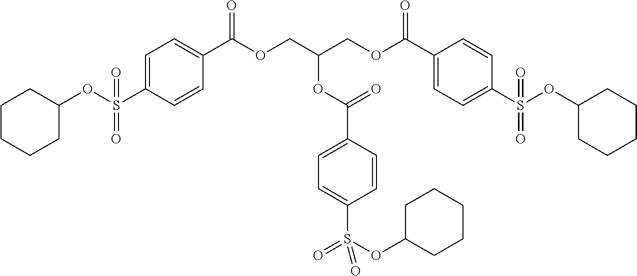 [SMILES: O=C(OCC(COC(=O)c1ccc(S(=O)(=O)OC2CCCCC2)cc1)OC(=O)c1ccc(S(=O)(=O)OC2CCCCC2)cc1)c1ccc(S(=O)(=O)OC2CCCCC2)cc1] | Multidev-1 |
| 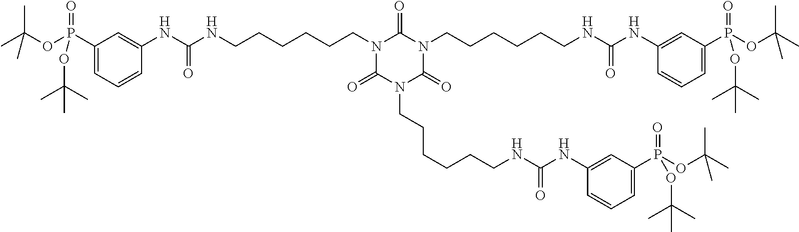 [SMILES: CC(C)(C)OP(=O)(OC(C)(C)C)c1cccc(NC(=O)NCCCCCCn2c(=O)n(CCCCCCNC(=O)Nc3cccc(P(=O)(OC(C)(C)C)OC(C)(C)C)c3)c(=O)n(CCCCCCNC(=O)Nc3cccc(P(=O)(OC(C)(C)C)OC(C)(C)C)c3)c2=O)c1] | Multidev-2 |
| 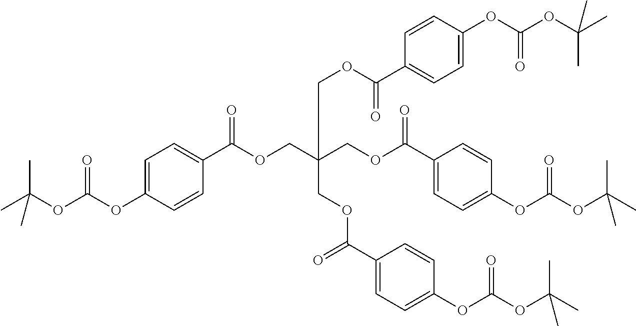 [SMILES: CC(C)(C)OC(=O)Oc1ccc(C(=O)OCC(COC(=O)c2ccc(OC(=O)OC(C)(C)C)cc2)(COC(=O)c2ccc(OC(=O)OC(C)(C)C)cc2)COC(=O)c2ccc(OC(=O)OC(C)(C)C)cc2)cc1] | Multidev-3 |

### Polymerisable Colour Developing Agents or Colour Developing Agent Precursors.

In the embodiment wherein a UV curable composition, for example a UV curable inkjet ink, a polymerisable colour developing agent or colour developing agent precursor, is preferably used.

Upon UV curing the composition, the colour developing agent or colour developing agent precursor are copolymerized together with the other monomers of the composition. As part of the resulting polymeric network, the colour developing agent or colour developing agent precursor also become diffusion hindered.

Typical polymerisable colour developing agent or colour developing agent precursor are given in Table 9 without being limited thereto.

TABLE 9

| | |
|---|---|
| 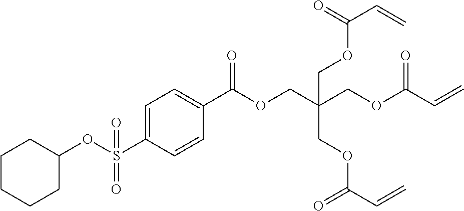 [SMILES: C=CC(=O)OCC(COC(=O)C=C)(COC(=O)C=C)COC(=O)c1ccc(S(=O)(=O)OC2CCCCC2)cc1] | Monodev-1 |
| 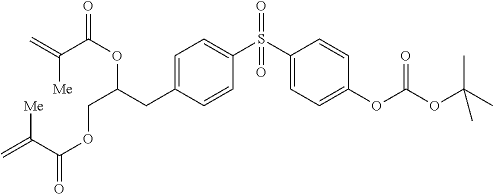 [SMILES: C=C(C)C(=O)OCC(Cc1ccc(S(=O)(=O)c2ccc(OC(=O)OC(C)(C)C)cc2)cc1)OC(=O)C(=C)C] | Monodev-2 |
| 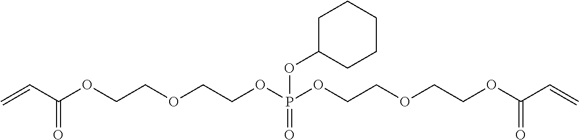 [SMILES: C=CC(=O)OCCOCCOP(=O)(OCCOCCOC(=O)C=C)OC1CCCCC1] | Monodev-3 |
| 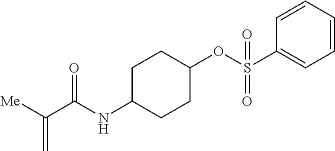 [SMILES: C=C(C)C(=O)NC1CCC(OS(=O)(=O)c2ccccc2)CC1] | Monodev-4 |
| 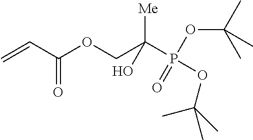 [SMILES: C=CC(=O)OCC(C)(O)P(=O)(OC(C)(C)C)OC(C)(C)C] | Monodev-5 |

### Compounds Containing a Leuco Dye and a Colour Developing Agent (Precursor)

In a particularly preferred embodiment, a diffusion hindered leuco dye and an diffusion hindered colour developing agent or colour developing agent precursor are integrated into the same multifunctional, polymeric or oligomeric structure to guarantee close proximity of the colour developing agent or colour developing agent precursor and the leuco dye.

Such compounds may be prepared by copolymerisation of polymerisable leuco dyes, polymerisable colour developing agents or colour developing agent precursors, by post-derivatisation of a polymeric leuco polymer with a reactive colour developing agent or colour developing agent precursor, by post-derivatisation of a polymeric colour developing agent or colour developing agent precursor polymer with a reactive leuco dye, or by polycondensation of a reactive leuco dye and a reactive colour developing agent or colour developing agent precursor.

Typical examples of such leuco dye—colour developing agent precursor copolymers are given in Table 10 without being limited thereto.

TABLE 10

| | |
|---|---|
| 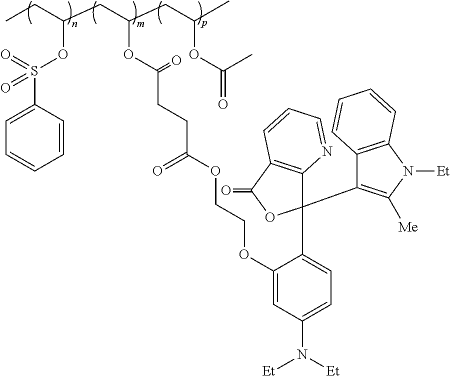 | Polyleucodev-1 |
| 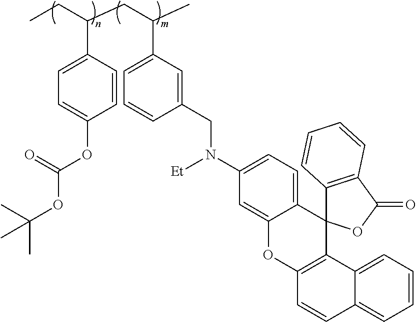 | Polyleucodev-2 |
| 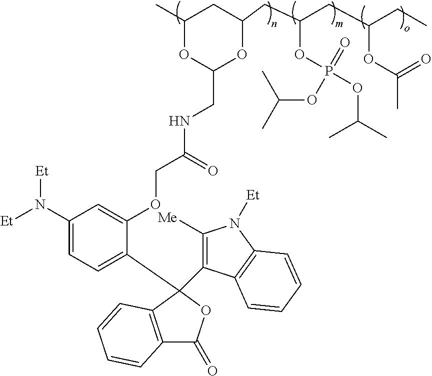 | Polyleucodev-3 |

### Optothermal Converting Agent

An optothermal converting agent generates heat upon absorption of radiation. The optothermal converting agent preferably generates heat upon absorption of infrared radiation.

The optothermal converting agent is preferably an infrared absorbing dye, an infrared absorbing pigment, or a combination thereof.

### Infrared Absorbing Dyes

Suitable examples of infrared absorbing dyes (IR dyes) include, but are not limited to, polymethyl indoliums, metal complex IR dyes, indocyanine green, polymethine dyes, croconium dyes, cyanine dyes, merocyanine dyes, squarylium dyes, chalcogeno-pyryloarylidene dyes, metal thiolate complex dyes, bis(chalcogenopyrylo)-polymethine dyes, oxyindolizine dyes, bis(aminoaryl)polymethine dyes, indolizine dyes, pyrylium dyes, quinoid dyes, quinone dyes, phthalocyanine dyes, naphthalo-cyanine dyes, azo dyes, (metalized) azomethine dyes and combinations thereof.

Preferred infrared absorbing dyes are polymethine dyes due to their low absorption in the visible region and their selectivity, i.e. narrow absorption peak in the infrared region. Particular preferred polymethine infrared dyes are cyanine infrared dyes.

Preferred infrared absorbing dyes having an absorption maximum of more than 1100 nm are those disclosed in EP-A 2722367, paragraphs [0044] to [0083] and the unpublished EP-A 14166498.7 (filed on 30 Apr 2014).

Infrared absorbing dyes having an absorption maximum between 1000 nm and 1100 nm are preferably selected from the group consisting of quinoline dyes, indolenine dyes, especially a benzo[cd]indoline dye. A particularly preferred infrared dye is 5-[2,5-bis[2-[1-(1-methylbutyl)-benz[cd]indol-2(1H)-ylidene]ethylidene]-cyclopentylidene]-1-butyl-3-(2-methoxy-1-methylethyl)-2,4,6(1H,3H,5H)-pyrimidinetrione (CASRN 223717-84-8) represented by the Formula IR-1:

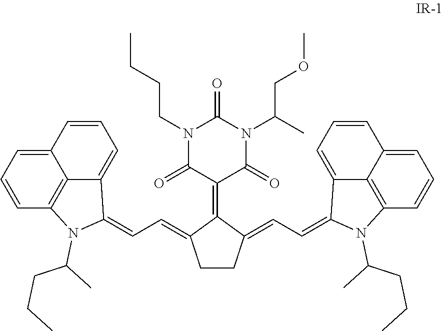 [SMILES: CCCCN1C(=O)C(=C2/C(=C/C=c3\c4cccc5cccc(c54)n3C(C)CCC)CC/C2=C\C=c2/c3cccc4cccc(c43)n2C(C)CCC)C(=O)N(C(C)COC)C1=O]

The infrared absorbing dyes IR-1 has an absorption maximum λₘₐₓ of 1052 nm making it very suitable for a Nd-YAG laser having an emission wavelength of 1064 nm.

Infrared absorbing dyes having an absorption maximum between 830 nm and 1000 nm are preferably selected from the group consisting of quinoline dyes, indolenine dyes, especially benzo[e]indolenine dyes, and benzo[f]indolenine dyes.

An advantage of using infrared absorbing dyes is that the absorption spectrum of an infrared absorbing dye tends to be narrower than that of an Infrared absorbing pigment. This allows the production of multicoloured articles and security documents from precursors having a plurality of laser markable layers containing different IR dyes and colour forming compounds. The IR dyes having a different maximum absorption wavelength can then be addressed by IR lasers with corresponding emission wavelengths causing colour formation only in the laser markable layer of the addressed IR dye. Such multicolour articles have been disclosed in for example U.S. Pat. No. 4,720,449, EP-A 2719540 and EP-A 2719541.

The amount of the IR dyes is preferably between 0.005 and 1.000 g/m², more preferably between 0.010 and 0.500 g/m², most preferably between 0.015 and 0.050 g/m². Enough IR dye has to be present to ensure sufficient colour density formation upon exposure to IR radiation. However, using too much IR dye may result in unwanted background colouration of the laser markable materials.

Water soluble infrared dyes can be added as such to an aqueous composition. However, preferred infrared dyes are often not, or slightly, soluble in aqueous media. Such infrared dyes can be added to the composition as an aqueous dispersion. Particularly preferred, such infrared dyes may be incorporated into the core of a capsule, for example the capsule containing the leuco dye.

### Infrared Absorbing Pigments

Suitable examples of infrared absorbing pigments include but are not limited to carbon black such as acetylene black, channel black, furnace black, lamp black, and thermal black; oxides, hydroxides, sulfides, sulfates and phosphates of metals such as copper, bismuth, iron, nickel, tin, zinc, manganese, zirconium, tungsten, lanthanum, and antimony including lanthane hexaboride, indium tin oxide (ITO) and antimony tin oxide, titanium black and black iron oxide.

The infrared dye classes disclosed above may also be used as infrared absorbing pigments, for example cyanine pigment, merocyanine pigment, etc.

A preferred infrared absorbing pigment is carbon black.

The particle size of the pigment is preferably from 0.01 to 5 μm, more preferably from 0.05 to 1 μm, most preferably from 0.10 to 0.5 μm.

The amount of the infrared absorbing pigment is between 10 and 1000 ppm, preferably between 25 and 750 ppm, more preferably between 50 and 500 ppm, most preferably between 100 and 250 ppm, all relative to the total dry weight of the laser markable layer. An amount of infrared absorbing pigment above 1000 ppm results in a too high background density of the laser markable article.

Aqueous dispersions of carbon black are preferably used in the present invention. Examples of such aqueous carbon black dispersions are CAB-O-JET® 200 and 300 from CABOT.

Optothermal converting agents may become “diffusion hindered” by:
including the optothermal converting agent in the core of a capsule composed of a polymeric shell surrounding a core;
linking two or more basic optothermal converting agent to each other whereby the total molecular weight of the resulting compound becomes at least twice the molecular weight of the basic ingredient with the proviso that the total molecular weight is at least 500, more preferably at least 750 and most preferably at least 1000.

By using a diffusion hindered optothermal converting agent, the risk of penetrating through a food or pharmaceutical packaging is minimized. Furthermore, the optothermal converting agent cannot be extracted by moisture, e.g. by sweaty hands, before heat treatment or verification of the authenticity of the packaging.

### Capsules

The optothermal converting agent may be become “diffusion hindered” by including the optothermal converting agent in the core of a capsule composed of a polymeric shell surrounding a core.

The preparation and properties of such capsules are similar as for the capsules containing a leuco dye described above.

### Multifunctional, Oligomeric and Polymeric Optothermal Converting Agents

Optothermal converting agents may also become diffusion hindered by polymerizing or co-polymerizing the optothermal converting agent to form a polymeric optothermal converting agent or by post derivation of a polymeric resin with an optothermal converting agent.

The preparation and the properties of the polymeric optothermal converting agents are similar as for the polymeric leuco dyes described above.

According to another embodiment, an optothermal converting agent may become diffusion hindered by linking two or more basic optothermal converting agents to each other whereby the total molecular weight becomes at least twice the molecular weight of the basic optothermal converting agent with the proviso that the total molecular weight is at least 500, more preferably at least 750 and most preferably at least 1000.

Typical examples of multifunctional, oligomeric or polymeric optothermal converting agents are given in Table 11 without being limited thereto.

TABLE 11

| | |
|---|---|
| 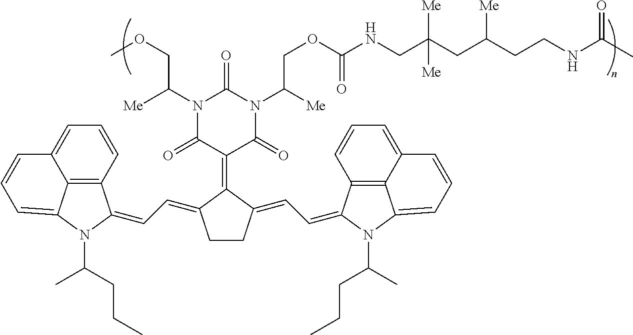 | IR-1 |
| 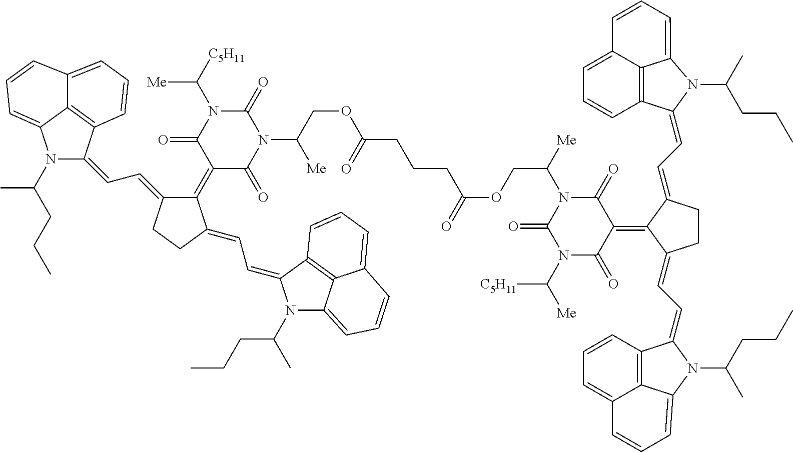 | IR-2 |
| 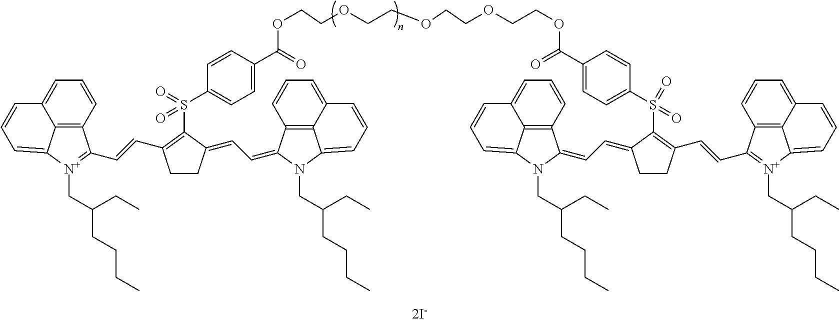 | IR-3 |
| 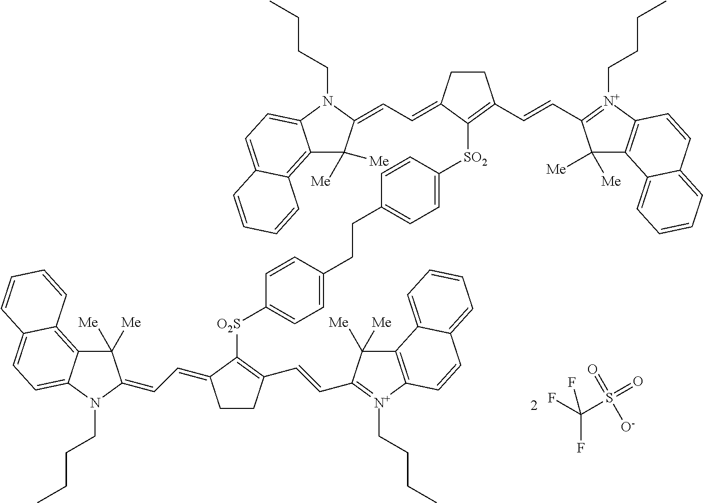 [SMILES: CCCCN1/C(=C/C=C2\CCC(/C=C/C3=[N+](CCCC)c4ccc5ccccc5c4C3(C)C)=C2S(=O)(=O)c2ccc(CCc3ccc(S(=O)(=O)C4=C(/C=C/C5=[N+](CCCC)c6ccc7ccccc7c6C5(C)C)CC/C4=C\C=C4\N(CCCC)c5ccc6ccccc6c5C4(C)C)cc3)cc2)C(C)(C)c2c1ccc1ccccc21 ; O=S(=O)([O-])C(F)(F)F] | IR-4 |
| 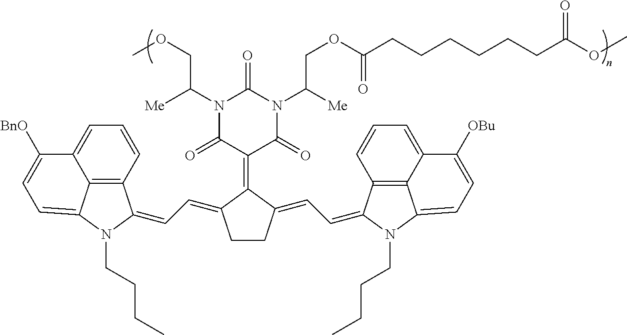 | IR-5 |

### Polymeric Binder

The laser markable composition may include a polymeric binder. In principle any suitable polymeric binder that does not prevent the colour formation in a laser markable layer may be used. The polymeric binder may be a polymer, a copolymer or a combination thereof.

The laser markable composition preferably includes a water soluble or dispersible binder.

Examples of water soluble or dispersible binder are homopolymers and copolymers of vinyl alcohol, (meth)acrylamide, methylol (meth)acrylamide, (meth)acrylic acid, hydroxyethyl (meth)acrylate, maleic anhydride/vinylmethylether copolymers, copolymers of (meth)acrylic acid or vinylalcohol with styrene sulphonic acid, vinyl alcohol/vinylacetate copolymers, carboxy-modified polyvinyl alcohol, carboxymethyl cellulose, hydroxyethyl cellulose, cellulose sulfate, polyethylene oxides, gelatin, cationic starch, casein, sodium polyacrylate, styrene-maleic anhydride copolymer sodium salt, sodium polystyrene sulfonate.

Preferred vinyl alcohol-vinyl acetate copolymers are disclosed in EP-A 2103736, paragraph [79]-[82].

Other preferred water soluble or dispersible binders are the copolymers comprising alkylene and vinyl alcohol units disclosed in EP-A 2457737 paragraph [0013] to [0023] such as the Exceval™ type polymers from Kuraray.

### Acid Scavenger

The laser markable composition or another layer of the packaging may contain one or more acid scavengers.

Acid scavengers include organic or inorganic bases. Examples of the inorganic bases include hydroxides of alkali metals or alkaline earth metals; secondary or tertiary phosphates, borates, carbonates; quinolinates and metaborates of alkali metals or alkaline earth metals; a combination of zinc hydroxide or zinc oxide and a chelating agent (e.g., sodium picolinate); hydrotalcite such as Hycite 713 from Clariant; ammonium hydroxide; hydroxides of quaternary alkylammoniums; and hydroxides of other metals. Examples of the organic bases include aliphatic amines (e.g., trialkylamines, hydroxylamines and aliphatic polyamines); aromatic amines (e.g., N-alkyl-substituted aromatic amines, N-hydroxylalkyl-substituted aromatic amines and bis[p-(dialkylamino)phenyl]-methanes), heterocyclic amines, amidines, cyclic amidines, guanidines and cyclic guanidines.

Other preferred acid scavangers are HALS compounds. Example of suitable HALS include Tinuvin™ 292, Tinuvin™ 123, Tinuvin™ 1198, Tinuvin™ 1198 L, Tinuvin™ 144, Tinuvin™ 152, Tinuvin™ 292, Tinuvin™ 292 HP, Tinuvin™ 5100, Tinuvin™ 622 SF, Tinuvin™ 770 DF, Chimassorb™ 2020 FDL, Chimassorb™ 944 LD from BASF; Hostavin 3051, Hostavin 3050, Hostavin N 30, Hostavin N321, Hostavin N 845 PP, Hostavin PR 31 from Clariant.

Further examples of acid scavengers are salts of weak organic acids such as carboxylates (e.g. calcium stearate).

A preferred acid scavenger is an organic base, more preferably an amine. A particular preferred acid scavenger is an organic base having a pKb of less than 7.

### UV Absorbers

The packaging may also comprise a UV-absorber. The UV-absorber may be present in a laser markable composition or may also be present in another layer, for example an outer layer.

Examples of suitable UV-absorbers include 2-hydroxyphenyl-benzophenones (BP) such as Chimassorb™ 81 and Chimassorb™ 90 from BASF; 2-(2-hydroxyphenyl)-benzotriazoles (BTZ) such as Tinuvin™ 109, Tinuvin™ 1130, Tinuvin™ 171, Tinuvin™ 326, Tinuvin™ 328, Tinuvin™ 384-2, Tinuvin™ 99-2, Tinuvin™ 900, Tinuvin™ 928, Tinuvin™ Carboprotect™, Tinuvin™ 360, Tinuvin™ 1130, Tinuvin™ 327, Tinuvin™ 350, Tinuvin™ 234 from BASF, Mixxim™ BB/100 from FAIRMOUNT, Chiguard 5530 from Chitec; 2-hydroxy-phenyl-s-triazines (HPT) such as Tinuvin™ 460, Tinuvin™ 400, Tinuvin™ 405, Tinuvin™ 477, Tinuvin™ 479, Tinuvin™ 1577 ED, Tinuvin™ 1600 from BASF, 2-(2,4-dihydroxyphenyl)-4,6-bis-(2,4-dimethylphenyl)-s-triazine (CASRN1668-53-7) from Capot Chemical Ltd and 4-[4,6-bis(2-methyl-phenoxy)-1,3,5-triazin-2-yl]-1,3-benzenediol (CASRN13413-61-1); titanium dioxide such as Solasorb 100F from from Croda Chemicals; zink oxide such as Solasorb 200F from Croda Chemicals; benzoxazines such as Cyasorb UV-3638 F, CYASORB™ UV-1164 from CYTEC; and oxamides such as Sanduvor VSU from Clariant.

Preferred UV absorbers have in the wavelength region between 300 and 400 nm a maximum absorption above 330 nm, more preferably above 350 nm.

Particular preferred UV absorbers are hydroxyphenyl benzotriazoles and 2-hydroxyphenyl-s-triazines having a maximum absorption above 350 nm in the wavelength region 300-400 nm.

### Primer

A primer may be applied between the substrate and the laser markable compositon(s) to improve the adhesion between the laser markable layer and the substrate. The primer may be optimized, depending on the type of substrate.

A primer typically comprises a vinylidene copolymer, a polyurethane, a polyester, a (meth)acrylate, or a combination thereof.

Useful primers are well known in the art and include, for example, polymers of vinylidene chloride such as vinylidene chloride/acrylonitrile/acrylic acid terpolymers or vinylidene chloride/methyl acrylate/itaconic acid terpolymers.

Other preferred primers include a binder based on a polyester-urethane copolymer. In a more preferred embodiment, the polyester-urethane copolymer is an ionomer type polyester urethane, preferably using polyester segments based on terephthalic acid and ethylene glycol and hexamethylene diisocyanate. A suitable polyester-urethane copolymer is Hydran™ APX101 H from DIC Europe GmbH.

The application of subbing layers is well-known in the art of manufacturing polyester supports for silver halide photographic films. For example, the preparation of such subbing layers is disclosed in U.S. Pat. No. 3,649,336 and GB 1441591.

In a preferred embodiment, the primer has a dry thickness of no more than 0.2 μm or preferably no more than 200 mg/m².

### White Primer

The white primer contains a white pigment. The white pigment may be an inorganic or an organic pigment.

The white pigment may be selected from titanium oxide, barium sulfate, silicon oxide, aluminium oxide, magnesium oxide, calcium carbonate, kaolin, or talc.

A preferred white pigment is titanium oxide.

Titanium oxide occurs in the crystalline forms of anatase type, rutile type and brookite type. The anatase type has a relatively low density and is easily ground into fine particles, while the rutile type has a relatively high refractive index, exhibiting a high covering power. Either one of these is usable in this invention. It is preferred to make the most possible use of characteristics and to make selections according to the use thereof. The use of the anatase type having a low density and a small particle size can achieve superior dispersion stability, ink storage stability and ejectability. At least two different crystalline forms may be used in combination. The combined use of the anatase type and the rutile type which exhibits a high colouring power can reduce the total amount of titanium oxide, leading to improved storage stability and ejection performance of ink.

For surface treatment of the titanium oxide, an aqueous treatment or a gas phase treatment is applied, and an alumina-silica treating agent is usually employed. Untreated-, alumina treated- or alumina-silica treated-titanium oxide are employable.

The volume average particle size of the white pigment is preferably between 0.03 μm and 0.8 μm, more preferably between 0.15 μm and 0.5 μm. When the volume average particle size of the white pigment is within these preferred ranges, the reflection of light is sufficient to obtain a sufficiently dense white colour. The volume average particle size may be measured by a laser diffraction/scattering type particle size distribution analyzer.

The white primer may be provided onto the packaging by co-extrusion or any conventional coating technique, such as dip coating, knife coating, extrusion coating, spin coating, spray coating, slide hopper coating and curtain coating.

Alternatively, the laser markable composition and the primer may be provided onto the substrate by a printing method such as intaglio printing, screen printing, flexographic printing, offset printing, inkjet printing, gravure offset printing, tampon printing, etc.

The white primer may be water based or UV curable.

When the white primer is applied by inkjet printing, preferably UV curable inkjet printing, the white pigment particles in the white inkjet ink should be sufficiently small to permit free flow of the ink through the inkjet-printing device, especially at the ejecting nozzles. It is also desirable to use small particles to slow down sedimentation. The numeric average particle diameter of the titanium oxide is preferably from 50 to 500 nm, more preferably from 150 to 400 nm, and most preferably from 200 to 350 nm. Sufficient hiding power cannot be obtained when the average diameter is less than 50 nm, and the storage ability and the jet-out suitability of the ink tend to be degraded when the average diameter exceeds 500 nm.

Preferred white pigments have a high refractive index, preferably a refractive index greater than 1.60, preferably greater than 2.00, more preferably greater than 2.50 and most preferably greater than 2.60. Such white pigments generally have a very covering power, i.e. a limited amount of white primer is necessary to hide the colour and defects of the substrate on which it is printed. Unfortunately, such white pigments also generally exhibit a high sedimentation degree and speed.

Suitable white pigments having high refractive index are given in Table 12. The white pigments may be employed singly or in combination. The most preferred white pigment is titanium dioxide.

TABLE 12

| C.I. Number | Chemical name | CAS RN |
|---|---|---|
| Pigment white 1 | Lead hydroxide | 1319-46-6 |
| | carbonate | |
| Pigment white 3 | Lead sulphate | 7446-14-2 |
| Pigment white 4 | Zinc oxide | 1314-13-2 |
| Pigment white 5 | Lithopone | 1345-05-7 |
| Pigment white 6 | Titanium dioxide | 13463-67-7 |
| Pigment white 7 | Zinc sulphide | 1314-98-3 |
| Pigment white 10 | Barium carbonate | 513-77-9 |
| Pigment white 11 | Antimony trioxide | 1309-64-4 |
| Pigment white 12 | Zirconium oxide | 1314-23-4 |
| Pigment white 14 | Bismuth oxychloride | 7787-59-9 |
| Pigment white 17 | Bismuth subnitrate | 1304-85-4 |
| Pigment white 18 | Calcium carbonate | 471-34-1 |
| Pigment white 19 | Kaolin | 1332-58-7 |
| Pigment white 21 | Barium sulphate | 7727-43-7 |
| Pigment white 24 | Aluminum hydroxide | 21645-51-2 |
| Pigment white 25 | Calcium sulphate | 7778-18-9 |
| Pigment white 27 | Silicon dioxide | 7631-86-9 |
| Pigment white 28 | Calcium metasilicate | 10101-39-0 |
| Pigment white 32 | Zinc phosphate cement | 7779-90-0 |

When used for food packaging or pharmaceutical applications, the white primer is preferably a “low migration” white primer.

Such a low migration white primer is preferably prepared by using a low migration white UV curable ink. The white pigment may be incorporated into the low migration UV curable inks described above.

An example of such a low migration UV curable white ink is disclosed in WO2014/032936, for example the white ink used in example 4.

### Packaging

There is no real limitation on the type of substrate used for the packaging. The substrates for inkjet printing may have plastic, glass or metal surfaces or may have a surface containing cellulosic fibres, such as paper and card board. The substrate may be an unprimed substrate but may also be a primed substrate, e.g. by a white primer.

The advantages are especially obtained for those types of packaging where traceability and serialization come into play.

Traceability is a major concern, and often a requirement for the medical and pharmaceutical community. In the event of a product recall, public safety and health are at risk. Manufacturers need the ability to quickly and positively identify and isolate all suspect products in the supply chain. Traceability is important for a packaging selected from the group consisting of food packaging, drink packaging, cosmetical packaging and medical packaging.

The basics of serialization (lot codes, batch codes, item numbers, time and date stamp) enable traceability from origination at the point of manufacture to the end of the supply chain. This data can be in the form of human readable text or through the use of coding, such as bar codes and QR codes, which aids in the process of authenticating the data electronically. Serialization is important for consumer packaged goods, such as electronic components, toys, computers and other electronic consumer goods.

The current invention can also be used to check the authenticity of the product bought by a customer. Currently, this is a great concern for pharmaceuticals, since many fake or inferior products circulate via the internet. The colour forming inkjet ink can provide a unique QR code on the package when it is filled, which can be scanned by a smart phone using an application downloadable form the Apple™ or Google™ webstore for verifying the authenticity.

In a preferred embodiment, the packaging is a drink packaging or a “primary” food packaging. Primary food packaging is the material that first envelops the product and holds it. This usually is the smallest unit of distribution or use and is the package which is in direct contact with the contents. Of course, for food safety reasons the inkjet inks may also be used for secondary and tertiary packaging. Secondary packaging is outside the primary packaging, perhaps used to group primary packages together. Tertiary packaging is used for bulk handling, warehouse storage and transport shipping. The most common form of tertiary packaging is a palletized unit load that packs tightly into containers.

The packaging may be transparent, translucent or opaque. There is no restriction on the shape of the packaging. It can be a flat sheet, such as polymeric film and metal sheet, or it can be a three dimensional object like a bottle or jerry-can.

A particularly preferred drink packaging is a plastic bottle having a surface of a polyester selected from the group consisting of polyethylene terephthalate (PET), polyethylene naphthalate (PEN), polylactide (PLA), and polyethylene isosorbide terephthalate (PEIT). PET is particularly preferred for reasons of recyclability.

Another particularly preferred drink packaging in the present invention is aluminium cans and aluminium bottles.

The packaging may be preprinted with flexo or offset. In a preferred embodiment, variable data are provided on a packaging containing a preprinted image by the method according to the present invention.

To position the variable data the preprinted image may comprise orientation points.

Using a camera of scanner, the variable data may be positioned relative to such orientation points or relative to the edges of the image.

### Additional Layers

To further improve the daylight and/or weather resistance of the laser markerd packaging, it may be advantageous to provide a top coat on the laser markable compositions wherein the top coat may contain one or more UV absorbing compounds or one or more light stabilizing compounds, such as for example HALS compounds.

It may also be advantageous to incorporate water barrier properties into the packaging to improve the stability of the laser marked image in high humid conditions, for example by incorporating one or more intermediate and/or top layers having such water barrier properties.

### Laser Marking

Laser marking is preferably carried out using an infrared laser.

The infrared laser may be a continuous wave or a pulsed laser.

A preferred infrared laser is a C0₂ laser. A C0₂ laser is a continuous wave, high power laser having an emission wavelength of typically 10600 nm (10.6 micrometer).

An advantage of using a carbon dioxide (C0₂) laser is the fact that laser markable sub-pixels without an optothermal converting agent may be used. This may result in an improved background colour as optothermal converting agents may give rise to unwanted colouration of the background.

A disadvantage of using a carbon dioxide (C0₂) laser is the rather long emission wavelength limiting the resolution of the marked image that can obtained.

Another preferred continuous wave laser is an optical pumped semiconductor laser. Optically pumped semiconductor lasers have the advantage of unique wavelength flexibility, different from any other solid-state based laser. The output wavelength can be set anywhere between about 920 nm and about 1150 nm. This allows a perfect match between the laser emission wavelength and the absorption maximum of an optothermal converting agent.

A preferred pulsed laser is a solid state Q-switched laser. Q-switching is a technique by which a laser can be made to produce a pulsed output beam. The technique allows the production of light pulses with extremely high peak power, much higher than would be produced by the same laser if it were operating in a continuous wave (constant output) mode, Q-switching leads to much lower pulse repetition rates, much higher pulse energies, and much longer pulse durations.

The advantage of using a laser having a wavelength between 800 and 1200 is the higher resolution that can be obtained, compared to the CO₂ laser described above.

When two or more lasers are used to laser mark two or more laser markable composition, the difference of the emission wavelengths of the two or more infrared laser is preferably at least 100 nm, more preferably at least 150 nm, most preferably at least 200 nm.

### Security Features

The method according to the present invention may also be used to form security features on a packaging.

The laser markable composition may be applied on the packaging thereby forming an “invisible” image. This “invisible” image can then be used as a security feature whereby the presence of the image may be verified by exposing the image to heat whereby the invisible image becomes visible.

Such “invisible” images may be combined with other visible images.

These other visible images may be prepared using the method according to the present invention, or may be applied on the packaging by another imaging method, for example offset or inkjet printing.

### QR Codes.

The method according to the present invention may be used to prepare so called QR code on the packaging.

QR code (abbreviated from Quick Response Code) is the trademark for a type of matrix barcode (or two-dimensional barcode) first designed for the automotive industry in Japan. A barcode is a machine-readable optical label that contains information about the item to which it is attached. A QR code uses four standardized encoding modes (numeric, alphanumeric, byte/binary, and kanji) to efficiently store data.

The QR Code system became popular outside the automotive industry due to its fast readability and greater storage capacity compared to standard UPC barcodes.

Applications include product tracking, item identification, time tracking, document management, and general marketing.

A QR code consists of black modules (square dots) arranged in a square grid on a white background, which can be read by an imaging device (such as a camera, scanner, etc.) and processed using Reed-Solomon error correction until the image can be appropriately interpreted. The required data are then extracted from patterns that are present in both horizontal and vertical components of the image.

The QR codes are typically applied on a packaging by a printing method, for example offset of inkjet printing or by laser marking with a CO₂ laser.

A CO₂ laser has an emission wavelength of 10600 nm.

In the method according to the present wherein a laser markable composition comprising an optothermal converting agent, a UV laser or an infrared laser having an emission wavelength between 800 and 1200 nm may be used.

The much smaller emission wavelength of such lasers compared to a CO₂ laser ensures a higher resolution of the laser marked QR code. Such a high resolution may improve the quality (i.e. readability) of the QR code or makes it possible to minimize the QR.

### EXAMPLES

### Materials

All materials used in the following examples were readily available from standard sources such as Aldrich Chemical Co. (Belgium) and Acros (Belgium) unless otherwise specified. The water used in the examples is demineralized water.

SDS™ Ultra Pure is Sodium dodecyl sulfate commercially available from AppliChem GmbH.

LD-1 is Wincon™ 205, a black leuco dye supplied by Connect Chemicals, having the following structure:

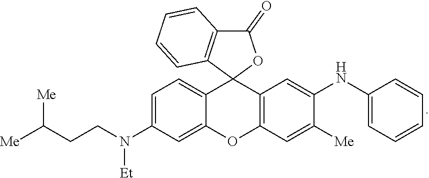 [SMILES: CCN(CCC(C)C)c1ccc2c(c1)Oc1cc(C)c(Nc3ccccc3)cc1C21OC(=O)c2ccccc21]

LD-2 is Pergascript™ Black IR, a black leuco dye supplied by BASF, having the following structure:

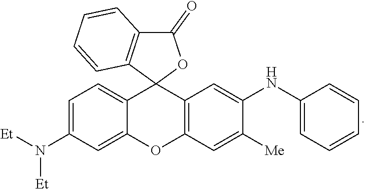 [SMILES: CCN(CC)c1ccc2c(c1)Oc1cc(C)c(Nc3ccccc3)cc1C21OC(=O)c2ccccc21]

LD-3 is Pergascript™ black 2C, a black leuco dye supplied by BASF, having the following structure:

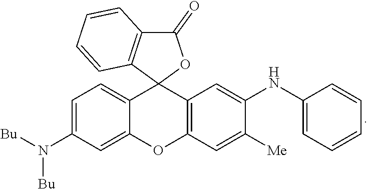

LD-4 is a red leuco dye supplied by Molekula Fine Chemicals, having the following structure:

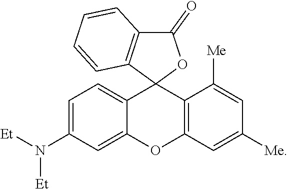 [SMILES: CCN(CC)c1ccc2c(c1)Oc1cc(C)cc(C)c1C21OC(=O)c2ccccc21]

LD-5 is Mitsui™ GN169, a blue leuco dye supplied by Mitsui, having the following structure:

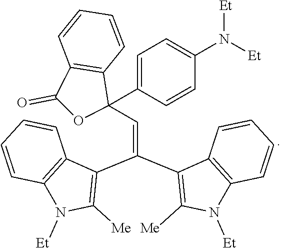 [SMILES: CCN(CC)c1ccc(C2(C=C(c3c(C)n(CC)c4ccccc34)c3c(C)n(CC)c4ccccc34)OC(=O)c3ccccc32)cc1]

LD-6 is Mitsui G2, a cyan leuco dye supplied by Mitsui, having the following structure:

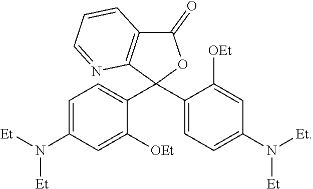 [SMILES: CCOc1cc(N(CC)CC)ccc1C1(c2ccc(N(CC)CC)cc2OCC)OC(=O)c2cccnc21]

LD-7 is Wincon™ Red, a leucodye (CASRN 50292-95-0) commercially available from Connect Chemicals.

LD-01 is a leuco dye prepared according to the following scheme:

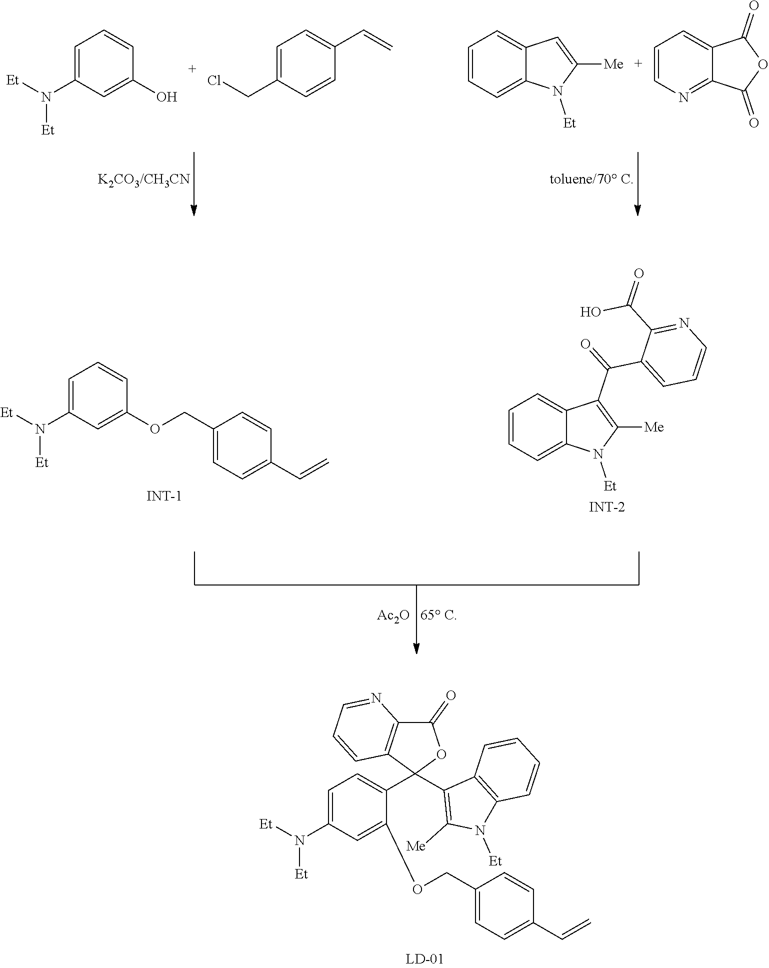

### Synthesis of Diethyl-[3-(4-vinyl-benzyloxy)-phenyl]-amine (INT-1)

10 g (63 mmol) 3-diethylamino-phenol was dissolved in 100 ml acetonitrile. 29.5 g (0.189 mol) potassium carbonate was added followed by the addition of 10.6 g (63 mmol) 4-chloromethyl-styrene. The mixture was heated to reflux for 9 hours. An additional 500 μl 4-chloromethyl-styrene was added and the reaction was allowed to continue for an additional one and a half hour. The reaction mixture was allowed to cool down to room temperature and the solvent was removed under reduced pressure. The residue was recrystallized twice from isopropanol. 7.5 g of diethyl-[3-(4-vinyl-benzyloxy)-phenyl]-amine was isolated (yield: 42%)

### Synthesis of 3-(1-Ethyl-2-methyl-1H-indole-3-carbonyl)-pyridine-2-carboxylic acid (INT-2)

7.4 g (50 mmol) furo[3,4-b]pyridine-5,7-dione was added to 50 ml toluene. 8.2 g (50 mmol) 1-ethyl-2-methyl-1H-indole was added dropwise and the mixture was heated to 74° C. The reaction was allowed to continue for five hours at 70° C. The reaction mixture was allowed to cool down to room temperature and the precipitated crude 3-(1-ethyl-2-methyl-1H-indole-3-carbonyl)-pyridine-2-carboxylic acid was isolated by filtration. The crude 3-(1-ethyl-2-methyl-1H-indole-3-carbonyl)-pyridine-2-carboxylic acid was recrystallized from isopropanol. 7.5 g of 3-(1-ethyl-2-methyl-1H-indole-3-carbonyl)-pyridine-2-carboxylic acid was isolated (yield: 50%).

### Synthesis of LD-01

7 g (23 mmol) 3-(1-ethyl-2-methyl-1H-indole-3-carbonyl)-pyridine-2-carboxylic acid was dissolved in 100 ml acetic anhydride. 6.5 g (23 mmol) diethyl-[3-(4-vinyl-benzyloxy)-phenyl]-amine was added and the reaction was allowed to continue for 16 hours at 65° C. The reaction mixture was allowed to cool down to room temperature. Leuco dye monomer LD-01 was isolated by filtration washed with 100 ml water and dried. 9 g of leuco dye monomer-1 was isolated (yield: 69%).

LD-02 is a leuco dye prepared according to the following scheme:

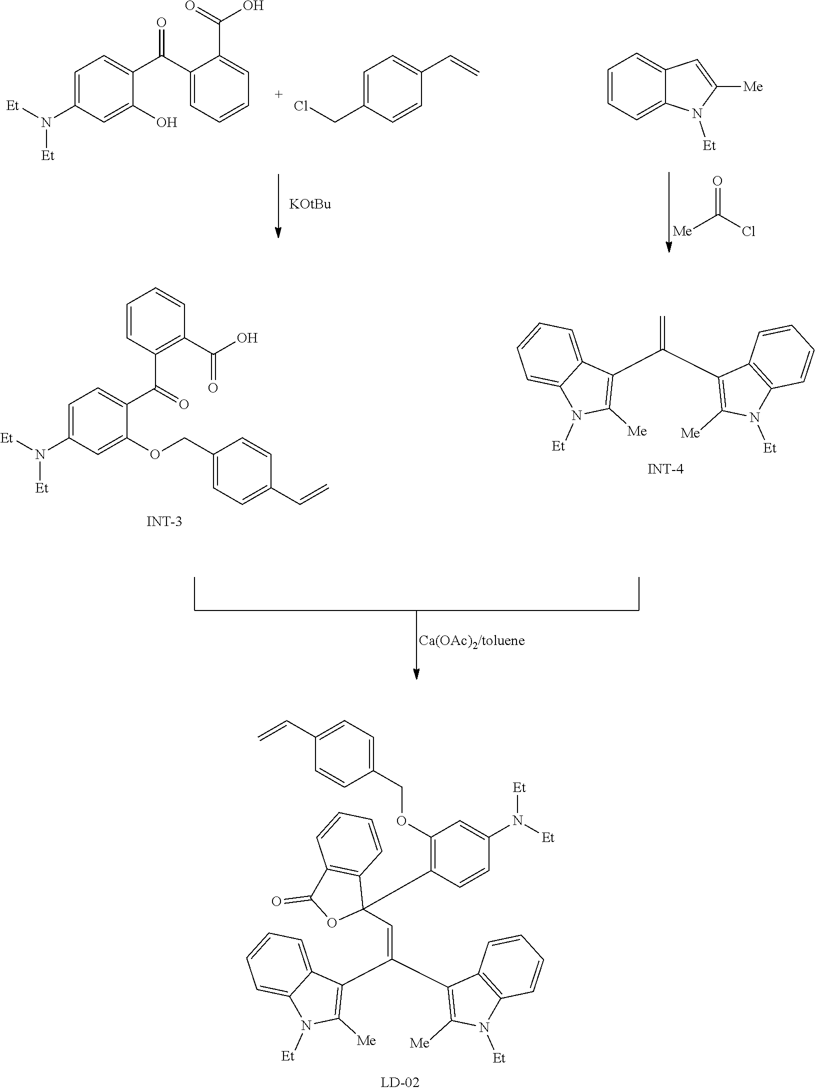

### Synthesis of 2-[4-Diethylamino-2-(4-vinyl-benzyloxy)-benzoyl]-benzoic acid (INT-3)

31.3 g (0.1 mol) 2-(4-diethylamino-2-hydroxy-benzoyl)-benzoic acid was dissolved in 300 ml dimethylacetamide. 23.0 g (0.204 mol) potassium tert.-butanolate was added and the mixture was stirred until complete dissolution. 32 g (0.21 mol) 4-chloromethyl-styrene was added and the mixture was heated to 70° C. for two hours. The reaction mixture was allowed to cool down to 40° C. and the mixture was added to 1.5 litre water. The precipitated product was isolated and redissolved in 300 ml methanol. 25 ml of a 5N NaOH solution was added and the mixture was heated to reflux for 3 hours. 500 ml water was slowly added and the mixture was allowed to cool down to 40° C. 25 ml acetic acid was added. The crude 2-[4-diethylamino-2-(4-vinyl-benzyloxy)-benzoyl]-benzoic acid precipitated from the medium, was isolated by filtration and washed with water. The crude 2-[4-diethylamino-2-(4-vinyl-benzyloxy)-benzoyl]-benzoic acid was dissolved in 300 ml methanol and precipitated with 1.5 litre water. 2-[4-Diethylamino-2-(4-vinyl-benzyloxy)-benzoyl]-benzoic acid was isolated by filtration and dried. The dried 2-[4-diethylamino-2-(4-vinyl-benzyloxy)-benzoyl]-benzoic acid was dissolved in 200 ml ethylacetate upon reflux. 600 ml hexane was added and the mixture was allowed to cool down to room temperature. 2-[4-Diethylamino-2-(4-vinyl-benzyloxy)-benzoyl]-benzoic acid was isolated by filtration and dried. 23 g of 2-[4-diethylamino-2-(4-vinyl-benzyloxy)-benzoyl]-benzoic acid was isolated (yield: 53%).

### Synthesis of 1-Ethyl-2-methyl-3-[1-(1-ethyl-2-methyl-1H-indol-3-yl)-vinyl]-1H-indole (INT-4)

8.0 g (50 mmol) 1-ethyl-2-methyl-1H-indole was dissolved in 7.5 ml acetic anhydride. 1.97 g (25 mmol) acetyl chloride was added and the reaction was allowed to continue at 55° C. for four hours. The reaction mixture was directly used further without further purification.

### Synthesis of Leuco Dye Monomer LD-02

To the reaction mixture of step 2, 13 ml toluene was added, followed by the addition of 4.4 g (25 mmol) calcium acetate hydrate and 10.8 g (25 mmol) 2-[4-diethylamino-2-(4-vinyl-benzyloxy)-benzoyl]-benzoic acid. The reaction was allowed to continue for two hours at 60° C. The reaction mixture as allowed to cool down to room temperature. 300 ml toluene, 200 ml water and 19 g of a 10 N NaOH solution were added. The mixture was stirred for 30 minutes at 60° C. The toluene fraction was isolated, washed with 300 ml water, dried over MgSO₄ and evaporated under reduced pressure. The crude leuco dye monomer-2 was isolated by preparative column chromatography on a Graceresolv RS80 column, using a gradient elution from 100% methylene chloride to methylene chloride/ethyl acetate 80/20. 8 g of leuco dye monomer-2 was isolated (yield: 46%).

LD-DISP-01 is a Dispersion of the Leuco Dye LD-04 and was Prepared as Follows:

100 g LD-04, 200 g of a 5 wt % solution of Aerosol OT-100 in water and 2 g of a 5 wt % solution of 1,2-benzisothiazol-3(2H)-one, potassium salt in water were mixed into 198 g water using a DISPERLUX™ dispenser. Stirring was continued for 30 minutes. The vessel was connected to a NETZSCH MiniZeta mill filled with 900 g of 0.4 mm yttrium stabilized zirconia beads (“high wear resistant zirconia grinding media” from TOSOH Co.). The mixture was circulated over the mill for 67 minutes (residence time of 20 minutes) and a rotation speed in the mill of about 10.4 m/s. During the complete milling procedure the content in the mill was cooled to keep the temperature below 60° C. After milling, the dispersion was discharged into a vessel. The resulting concentrated dispersion exhibited an average particle size of 193 nm as measured with a Malvern™ nano-S and a viscosity of 5 mPa·s at 25° C. and at a shear rate of 10 s⁻¹.

LD-DISP-02 is a Dispersion of the Leuco Dye LD-07 and was Prepared as Follows:

10 g LD-0-7, 20 g of a 5 wt % solution of Aerosol OT-100 in water, 0.375 g of a 8 wt % solution of sodium hydroxide in water and 0.2 g of a 5 wt % solution of 1,2-benzisothiazol-3(2H)-one, potassium salt in water were mixed into 19.425 g water and introduced into a 100 mL plastic container. The container was filed with 160 g of 3 mm yttrium stabilized zirconia beads (“high wear resistant zirconia grinding media” from TOSOH Co.). The container was sealed and placed on rotating rolls for 7 days. After roll milling, the dispersion exhibited an average particle size of 265 nm as measured with a Malvern™ nano-S.

CCE is Hydran APX-101H, a polyester urethane (45%) from DIC.

Resorcinol is commercially available from Sumitomo Chemicals.

Par is a dimethyltrimethylolamine formaldehyde resin from Cytec industries.

PAR-sol is a 40 wt % aqueous solution of Par.

PEA is Tospearl™ 120 from Momentive Performance Materials.

PEA-sol is a 10 wt % (50/50) aqueous/ethanol dispersion of PEA.

Dowfax™ 2A1 from Pilot Chemicals C is a Alkyldiphenyloxide disulfonate (4.5% wt).

DOW-sol is a 2.5 wt % solution of Dowfax™ 2A1 in isopropanol.

Surfynol™ 420 from Air Products is a non ionic surfactant.

Surfynsol is a 2.5 wt % solution of Surfynol™ 420 in isopropanol.

Sunvac™ HH is a copolymer of 86 wt % vinyl chloride and 14 wt % vinyl acetate provided by Yantal Suny Chem International Co., Ltd, China.

Tospearl™ 145 is available from Momentive Performance materials.

Tinogard™ AS, a UV absorber commercially available from BASF.

PET-C is Polyethylenterephtalate Substrate Prepared as Follows:

first a coating composition SUB-1 was prepared by mixing the components according to the following Table 13.

TABLE 13

| wt % of | |
|---|---|
| components | SUB-1 |
| water | 69.44 |
| CCE | 15.40 |
| Resorcinol | 12.55 |
| PAR-sol | 0.57 |
| PEA-sol | 0.68 |
| DOW-sol | 0.68 |
| Surfynsol | 0.68 |

A 1100 μm thick polyethylene terephthalate sheet was first longitudinally stretched and then coated on both sides with the coating composition SUB-1 at a wet coating thickness of 10 μm. After drying, the longitudinally stretched and coated polyethylene terephthalate sheet was transversally stretched to produce a double side subbed 63 μm thick sheet PET-C, which was transparent and glossy. Then an outer layer was prepared by coating the coating solution OUT-1 shown in Table 14 on one side of the PET-C foil at a wet coating thickness of 30 μm and dried at 90° C. during 6 minutes.

TABLE 14

| Ingredient (g) | OUT-1 |
|---|---|
| MEK | 87.85 |
| Sunvac ™ HH | 10.60 |
| Tospearl ™ 145 | 0.02 |
| Tinogard ™ AS | 1.50 |

Takenate™ D110N is a trifunctional isocyanate, supplied by Mitsui.

Tinuvin™ 928 is a UV absorber supplied by BASF, having the following structure:

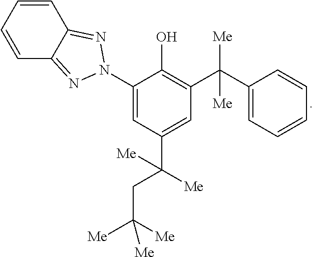 [SMILES: CC(C)(C)CC(C)(C)c1cc(-n2nc3ccccc3n2)c(O)c(C(C)(C)c2ccccc2)c1]

Olfine™ E1010 was supplied by Nissin Chemicals.

Bykjet™ 9152 is a polymer dispersing agent supplied by BYK.

IR-1 is an infrared dye, having the following structure:

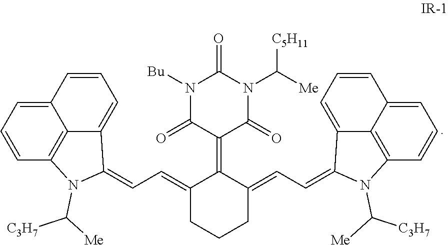

The infrared dye IR-1 was prepared according to the synthetic methodology, disclosed in EP 2463109 A (AGFA).

DEV-1 is a zinc salicylate complex supplied by Sanko Chemicals Europe, having the following structure:

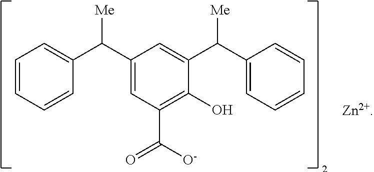

DEV-2 is a bisphenol compound supplied by TCI Europe, having the following structure:

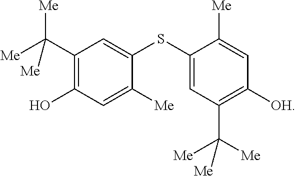 [SMILES: Cc1cc(O)c(C(C)(C)C)cc1Sc1cc(C(C)(C)C)c(O)cc1C]

DEV-3 is Lowinox™ 22M46, supplied by Chemtura, having the following structure:

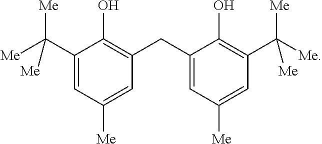 [SMILES: Cc1cc(Cc2cc(C)cc(C(C)(C)C)c2O)c(O)c(C(C)(C)C)c1]

Mowiol™ 488 is a polyvinyl alcohol supplied by Hoechst.

Marlon™ A365 is an anionic surfactant supplied by Sasol.

Tricresyl phosphate was supplied by Lanxess.

Proxel™ Ultra 5 is a biocide supplied by Avecia.

Alkanol™ XC is an anionic surfactant, supplied by Dupont.

CB-01, is Cab-O-Jet 300, a carbon black dispersion from CABOT CORPORATION, 300 times diluted.

Daran™ 8100, is a vinylidene copolymer-methyl acrylate polymer dispersion in water (60 wt %), commercially available from OWENSBORO SPECIALTY POLYMERS.

Buffer (pH 9) is a phospatebuffer (0.25M NaH₂PO₄).

DR306 is a surfactant solution according to Table 15

TABLE 15

| g of component | DR306 |
|---|---|
| Chemguard ™ | 52.6 |
| S228 | |
| Chemguard ™ | 52.6 |
| S550 | |
| Isopropanol | 473.0 |
| water | 431.0 |

Chemguard™ S228 is a blend of fluoro/silicone surfactants from CHEMGUARD INC.

Chemguard™ S550 is a short-chain perfluoro-based ethoxylated nonionic fluorosurfactant from CHEMGUARD INC.

### Measurement Methods

### 1. Average Particle Size

Unless otherwise specified, the average particle size was measured using a Brookhaven BI-90 Particle sizer.

### 2. Viscosity

The viscosity of the inkjet ink was measured using a Brookfield DV-II+ viscometer at 25° C. at 12 rotations per minute (RPM) using a CPE 40 spindle. This corresponds to a shear rate of 90 s⁻¹.

### 3. Surface Tension

The static surface tension of the radiation curable inks was measured with a KRUSS tensiometer K9 from KRUSS GmbH, Germany at 25° C. after 60 seconds.

### Example 1

This example illustrates an aqueous laser markable composition wherein the immobilized leuco dye is covalently bonded to polymeric particles.

### Preparation Immobilized Leuco Dyes LX-01 and LX-02

A polymer emulsion was prepared by means of a seeded emulsion polymerisation, wherein part of the monomers were brought into the reactor together with the surfactant before any initiator was added. All surfactant (3.5% relative to the total monomer amount) was added to the reactor before the reaction was started.

In a double-jacketed reactor of 700 ml, 1.12 gram SDS™ Ultra Pure and 206.39 gram of water was added. The reactor was put under an inert atmosphere by flushing with nitrogen. The reactor was then heated to 75° C. The monomer mixture used for preparing the seed was weighed in a dropping funnel, i.e. 1.06 gram of styrene, and 0.54 gram of acrylonitrile. When the surfactant solution reached 75° C., the seed monomer mixture was added instantaneously. The reactor was then heated for 15 minutes at 75° C. Subsequently 5.27 gram of a 2% aqueous solution of sodium persulfate was added (50% of the total initiator amount). Subsequently the reactor was heated during 30 minutes to 80° C. When the reactor reached 80° C., the monomer and initiator dosage was started. The monomer mixture of 19.92 gram of styrene and 8.83 gram of acrylonitrile and 1.6 gram of LD-01 was added during 3 hours. Simultaneously during the monomer addition, an aqueous persulfate solution was added (5.27 gram of a 2% aqueous solution of sodium persulfate). After the monomer dosing had finished, the reactor was kept at 80° C. for 1 hour. Residual monomer was removed by vacuum distillation for 1 hour at 80° C. and then the reactor was cooled to 20° C. The product was filtered using a 5 micron filter, resulting in the immobilized leuco dye dispersion LX-01 having a solid content of 12.1%, a pH of 4.6 and an average particle size of 37 nm.

LX-02 was prepared in the same manner as LX-01 except that LD-02 was used instead of LD-01. LX-02 had a solid content of 11.8%, a pH of 4.38 and an average particle size of 35 nm.

### Preparation Aqueous Laser Markable Compositions

The immobilized leuco dyes LX-01 and LX-02 and the colour developing agent precursor Daran™ 8100 were used to formulate the inventive aqueous inkjet ink INV-1 and INV-2 according to Table 16. The leuco dye dispersions LD-DISP-01 and LD-DISP-02 used to prepare the immobilized leuco dyes LX-01 and LX-02 were used to formulate a comparative aqueous inkjet ink COMP-1 according to Table 16

TABLE 16

| g of | | | |
|---|---|---|---|
| component | COMP-1 | INV-1 | INV-2 |
| water | 9.40 | — | — |
| Buffer (pH 9) | 5.00 | — | — |
| Daran ™ 8100 | 19.50 | 18.00 | 18.00 |
| NaOH (81 g/L) | 0.20 | 0.30 | 0.40 |
| LD-DISP-01 | 7.60 | — | — |
| LD-DISP-02 | 1.00 | — | — |
| LX-01 | — | 80.00 | — |
| LX-02 | — | — | 80.00 |
| CB-01 | 5.50 | 0.46 | 0.46 |
| DR306 | 2.00 | 1.00 | 1.00 |

The aqueous laser markable compostions were then coated on the side of the PET-C foil provided with SUB-1 layer at a wet coating thickness of 30 μm and dried at 90° C. during 6 minutes. The obtained coated samples were then laminated on both sides of a 600 μm PETG CORE (from Wolfen) using an OASYS OLA 6H laminator (130° C.-220 sec).

### Evaluation and Results

The laminated samples were then laser marked using a Muehlbauer™ CL 54 equipped with a Rofin™ RSM Powerline™ E laser (10 W) (1064 nm, 35 kHz).

The optical density of the laser marked areas were measured in reflection using a spectrodensitometer type Gretag™ Macbeth™ SPM50 using a visual filter.

To test the UV stability, the laminated samples were kept in a weathering cabinet equipped with a Xenon lamp for 72 hours after which the increase of the background density (ΔDmin) is measured.

The maximum optical densities (ODmax), the background optical densities (ODmin) and the increase of the background density upon UV exposure are shown in Table 17.

TABLE 17

| Sample | ODmax | ODmin | ΔDmin |
|---|---|---|---|
| COMP-1 | 1.8 | 0.1 | >1.0 |
| INV-1 | 1.2 | 0.1 | 0.1 |
| INV-2 | 1.3 | 0.2 | 0.0 |

From Table 17, it can be seen that all samples have the desired maximum optical density higher than 1.0, but the samples prepared with the inventive aqueous compositions INV-1 and INV-2 exhibited excellent UV stability.

### Example 2

This example illustrates an aqueous laser markable composition wherein the immobilized leuco dye is included in the core of capsules composed of a polymeric shell surrounding a core.

### Preparation of Capsules CAPS-1

5 g of LD-1, 1.2 g of LD-2, 3 g of LD-3, 4.9 g of LD-4, 4.9 g of LD-5, 2.4 g of LD-6 and 2.1 g of Tinuvin™ 928 were dissolved in 32 ml ethyl acetate by heating until reflux. The mixture was allowed to cool down to 60° C. and 23.1 g Takenate™ D110N and a solution of 50 mg of IR-1 in 2 ml methylene chloride were added. The mixture was allowed to cool down to room temperature. In a separate vessel, a solution of 8 g Bykjet™ 9152 and 0.12 g Olfine™ E1010 was prepared. This ethyl acetate solution was added to the aqueous solution under high shear, using a T25 digital Ultra-Turrax with an 18N rotor available from IKA at 24000 rpm for 5 minutes. The ethyl acetate was removed under reduced pressure, followed by removal of 20 g water to completely remove residual ethyl acetate. 20 ml water was added and the mixture was heated to 50° C. for 16 hours. After cooling down to room temperature, the mixture was filtered over a 1 μm filter. The average capsule size was estimated using an optical microscope to be about 400 nm.

### Preparation of Colour Developing Agent CDA-1

A solution of 9.75 g DEV-2, 9.75 g DEV-3, 30 g Tinuvin™ 928, 7.5 g tricresyl phosphate, 3.75 g diethyl maleate and 165 g DEV-1 in 450 g ethyl acetate was prepared by heating to 50° C.

In a separate vessel, a solution of 50 Mowiol™ 488, 7.5 g Marlon™ A365 and 4 g Proxel™ Ultra 5 in 715 ml water was prepared. The ethyl acetate solution was added to the aqueous solution using a HOMO-REX high speed homogenizing mixer. The mixture was stirred further for 5 minutes followed by removal of the ethyl acetate under reduced pressure. The particle size was measured using a Malvern nano-S. CDA-1 had an average particle size of 207 nm.

### Preparation Aqueous Laser Markable Composition INV-3

The immobilized leuco dye CAPS-1 and the colour developing agent CDA-1 were used to formulate the inventive laser markable compositions INV-3 according to Table 18. All weight percentages (wt %) are based on the total weight of composition.

TABLE 18

| w % of | |
|---|---|
| component | INV-3 |
| CDA-1 | 6.77 |
| CAP-1 | 3.82 |
| Glycerol | 42.16 |
| Alkanol ™ XC | 1.00 |
| water | 46.25 |

The composition was filtered over a 1.6 μm filter. The composition had a surface tension of 30 mN/m and a viscosity of 10 mPas at 22° C.

The inventive composition INV-3 was jetted using a Dimatix™ DMP2831 system, equipped with a standard Dimatix™ 10 pl print head. The inks were jetted at 22° C., using a firing frequency of 15 kHz, a firing voltage of 25 V and a standard waveform on a paper substrate to form a uniform square of 7 cm×7 cm, i.e. an invisible image (9). An additional square was printed on an Agfajet™ Transparency Film, supplied by Agfa.

An optically pumped semiconductor laser emitting at 1064 nm (Genesis MX 1064-10000 MTM from COHERENT) was used for producing a black wedge of 0.6 cm×0.6 cm square boxes of increasing optical density in the squares inkjet printed on both substrates. The laser was used at a power level of 4 W measured at the sample, a dither of 0.025, a scan speed of 200 mm/s and at a pulse repetition rate of 10 kHz.

A black wedge, i.e. a visible image, was laser marked in both inkjet printed squares.

1-15. (canceled)

16. A method of manufacturing a packaging comprising the steps of:
applying one or more laser markable compositions on at least a portion of the packaging; and
forming a color image by laser marking the one or more laser markable compositions applied to the packaging; wherein
the one or more laser markable compositions includes a leuco dye, a color developing agent or a color developing agent precursor, and optionally an optothermal converting agent.

17. The method of manufacturing a packaging according to claim 16, wherein the step of forming a color image by laser marking is performed with an infrared laser.

18. The method of manufacturing a packaging according to claim 16, wherein the step of applying the one or more laser markable compositions includes:
applying two or more laser markable compositions that form a cyan or blue color, a magenta or red color, or a yellow color upon laser marking.

19. The method of manufacturing a packaging according to claim 18, wherein the step of forming a color image by laser marking is performed with two or more infrared lasers having different emission wavelengths.

20. The method of manufacturing a packaging according to claim 16, further comprising the step of:
applying a white primer, a white label, or a pre-printed label between the packaging and the one or more laser markable compositions.

21. The method of manufacturing a packaging according to claim 16, wherein the packaging is selected from the group consisting of food packaging, drink packaging, cosmetic packaging, and pharmaceutical packaging.

22. The method of manufacturing a packaging according to claim 16, wherein the leuco dye and/or the color developing agent or the color developing agent precursor are diffusion hindered by:
including the leuco dye and/or the color developing agent or the color developing agent precursor in a core of a capsule composed of a polymeric shell surrounding the core;
polymerizing or co-polymerizing the leuco dye and/or the color developing agent or the color developing agent precursor to form a polymeric leuco dye and/or a polymeric color developing agent or a polymeric color developing agent;
linking two or more leuco dyes and/or color developing agents or color developing agent precursors to each other such that a total molecular weight of the leuco dye and/or the color developing agent or the color developing agent precursor is at least 500; or
linking the leuco dye and/or the color developing agent or the color developing agent precursor into a network upon UV exposing the one or more laser markable compositions.

23. The method of manufacturing a packaging according to claim 16, wherein the one or more laser markable compositions is a UV curable composition including a polymerizable leuco dye and/or a polymerizable color developing agent; and
the method further comprises the step of:
UV curing the UV curable composition before the step of forming a color image by laser marking.

24. A laser markable composition comprising:
a leuco dye;
a color developing agent or a color developing agent precursor; and
optionally an optothermal converting agent; wherein
the leuco dye and/or the color developing agent or the color developing agent precursor are diffusion hindered by:
including the leuco dye and/or the color developing agent or the color developing agent precursor in a core of a capsule composed of a polymeric shell surrounding the core;
polymerizing or co-polymerizing the leuco dye and/or the color developing agent or the color developing agent precursor to form a polymeric leuco dye and/or a polymeric color developing agent or a polymeric color developing agent;
linking two or more leuco dyes and/or color developing agents or color developing agent precursors to each other such that a total molecular weight of the leuco dye and/or the color developing agent or the color developing agent precursor is at least 500; or
linking the leuco dye and/or the color developing agent or the color developing agent precursor into a network upon UV exposing the laser markable composition.

25. The laser markable composition according to claim 24, wherein the optothermal converting agent is an infrared dye.

26. The laser markable composition according to claim 25, wherein the infrared dye is diffusion hindered by:
including the infrared dye in a core of a capsule composed of a polymeric shell surrounding the core;
polymerizing or co-polymerizing the infrared dye to form a polymeric infrared dye; or
linking two or more infrared dyes to each other such that a total molecular weight of the infrared dye is at least 500.

27. The laser markable composition according to claim 24, wherein the laser markable composition is an aqueous composition or a UV curable composition.

28. The laser markable composition according to claim 27, wherein the laser markable composition is the UV curable composition, and the leuco dye is a polymerizable leuco dye and/or the color developing agent is a polymerizable color developing agent.

29. The laser markable composition according to claim 27, the laser markable composition is the aqueous composition, and the aqueous composition includes the leuco dye and/or the color developing agent or the color developing agent precursor diffusion hindered by:
including the leuco dye and/or the color developing agent or the color developing agent precursor in the core of the capsule; or
polymerizing or co-polymerizing the leuco dye and/or the color developing agent or the color developing agent precursor to form a polymeric leuco dye and/or a polymeric color developing agent or a polymeric color developing agent.

30. A packaging comprising:
a color image including the laser marked composition according to claim 24.
